(19) United States
(12) Patent Application Publication
(10) Pub. No.: US 2026/0339234 A1
(43) Pub. Date: Oct. 29, 2026

(54) TONER CONTAINER AND IMAGE FORMING APPARATUS

(71) Applicant: CANON KABUSHIKI KAISHA, Tokyo (JP)

(72) Inventors: KAZUKI MATSUMOTO, Shizuoka (JP); HIROOMI MATSUZAKI, Shizuoka (JP); TORU OGUMA, Shizuoka (JP); TATSURO HARADA, Shizuoka (JP); NORITOMO YAMAGUCHI, Kanagawa (JP); AKINORI MITSUMATA, Tokyo (JP); KEI HAYASHIDA, Tokyo (JP)

(21) Appl. No.: 19/675,701

(22) Filed: May 13, 2026

Related U.S. Application Data
(63) Continuation of application No. PCT/JP2024/080205, filed on Nov. 25, 2024.

(30) Foreign Application Priority Data
Nov. 27, 2023 (JP) 2023-200228

(51) Int. Cl. G03G 15/08; G03G 21/18

(52) U.S. Cl. CPC G03G 15/0875; G03G 15/0879; G03G 15/0887; G03G 15/0896; G03G 21/1814; G03G 21/1842

(57) ABSTRACT

An image forming apparatus includes a cartridge including a container which constitutes a first chamber for accommodating toner and in which at least a part of a bottom thereof is constituted by a filter which permits passage of air and which prevents passage of the toner; an apparatus main assembly including a mounting portion to which the cartridge is mountable and a toner accommodating portion for accommodating the toner supplied from the cartridge mounted to the mounting portion; and an air supplying portion for supplying the air. The mounting portion includes a wall portion which is constituted so as to constitute a second chamber having an upper surface defined by the filter in a state in which the cartridge is mounted and which is provided with an intake port for taking the air, from the air supplying portion, into the second chamber.

### TECHNICAL FIELD

The present invention relates to a toner container detachably mountable to an image forming apparatus, and the image forming apparatus for forming an image on a recording material.

### BACKGROUND ART

In Japanese Laid-Open Patent Application No. 2007-249151, a toner supplying unit provided with an air pump for fluidizing toner in a toner tank and a pump of a diaphragm type for sucking the toner from the toner tank is described.

### SUMMARY OF THE INVENTION

### Means for Solving the Problem

An embodiment of the present invention is an image forming apparatus comprising: a cartridge including a container which constitutes a first chamber for accommodating toner and in which at least a part of a bottom thereof is constituted by a filter which permits passage of air and which prevents passage of the toner; an apparatus main assembly including a mounting portion to which the cartridge is mountable and a toner accommodating portion for accommodating the toner supplied from the cartridge mounted to the mounting portion; and an air supplying portion for supplying the air, wherein the mounting portion includes a wall portion which is constituted so as to constitute a second chamber having an upper surface defined by the filter in a state in which the cartridge is mounted and which is provided with an intake port for taking the air, from the air supplying portion, into the second chamber.

Another embodiment of the present invention is a toner container which is detachably mountable to an image forming apparatus and which includes a container frame provided with a first opening communicating with an outside of a toner container and a second opening larger in area than the first opening, and a filter such that passage of air is permitted and passage of toner is prevented and that the second opening is covered, wherein a toner accommodating chamber for accommodating the toner is constituted by the container frame and the filter, wherein in the case where the toner container takes a mounting orientation, the toner cartridge is constituted so that a bottom of the container frame is provided with the second opening, and wherein the filter constitutes a part of an outer surface of the toner container.

### BRIEF DESCRIPTION OF THE DRAWINGS

FIG. 1 is a sectional view of an image forming apparatus according to an embodiment 1.

FIG. 2 is a sectional view of a process cartridge according to the embodiment 1.

Parts (a) and (b) of FIG. 3 are sectional views of a toner cartridge according to the embodiment 1.

Parts (a) and (b) of FIG. 4 are sectional views of a toner cartridge according to a modified embodiment.

Parts (a) and (b) of FIG. 5 are cross-sectional perspective views of a toner cartridge according to the embodiment 1.

FIG. 6 is a perspective view of a filter member according to the embodiment 1.

FIG. 7 is a partially sectional view of the toner cartridge according to the embodiment 1.

FIG. 8 is a view of the toner cartridge according to the embodiment 1.

FIG. 9 is a sectional view of the toner cartridge and the process cartridge which are according to the embodiment 1.

FIG. 10 is a sectional view of a toner cartridge according to a modified embodiment.

FIG. 11 is a sectional view of a toner cartridge according to a modified embodiment.

Parts (a) and (b) of FIG. 12 are sectional views of a mounting portion and the toner cartridge which are according to the embodiment 1.

Parts (a) and (b) of FIG. 13 are sectional views of a mounting portion and the toner cartridge which are according to a modified embodiment.

Parts (a) and (b) of FIG. 14 are sectional views of a mounting portion and the toner cartridge which are according to a modified embodiment.

Parts (a) to (c) of FIG. 15 are illustrations of the toner cartridge according to the embodiment 1.

FIG. 16 is a sectional view of a toner cartridge according to an embodiment 2.

FIG. 17 is a sectional view of a toner cartridge according to a modified embodiment.

FIG. 18 is a cross-sectional perspective view of a toner cartridge according to an embodiment 3.

FIG. 19 is a cross-sectional perspective view of a toner cartridge according to a modified embodiment.

Parts (a) and (b) of FIG. 20 are sectional views of the toner cartridge according to the modified embodiment.

Parts (a) and (b) of FIG. 21 are cross-sectional perspective views of a toner cartridge according to an embodiment 4.

Parts (a) and (b) of FIG. 22 are sectional views of a toner cartridge according to an embodiment 5.

FIG. 23 is a sectional view of an image forming apparatus according to the embodiment 5.

FIG. 24 is a sectional view of the toner cartridge and a process cartridge which are according to the embodiment 5.

Parts (a) and (b) of FIG. 25 are sectional views of the toner cartridge according to the embodiment 5.

Parts (a) and (b) of FIG. 26 are sectional views of a toner cartridge according to a modified embodiment.

Parts (a) and (b) of FIG. 27 are sectional views of a toner cartridge according to a modified embodiment.

Parts (a) to (d) of FIG. 28 are illustrations of the toner cartridge according to the embodiment 5.

FIG. 29 is a cross-sectional perspective view of a toner cartridge according to an embodiment 6.

FIG. 30 is a cross-sectional perspective view of a toner cartridge according to a modified embodiment.

Parts (a) and (b) of FIG. 31 are sectional views of the toner cartridge according to the modified embodiment.

Parts (a) and (b) of FIG. 32 are cross-sectional perspective views of a toner cartridge according to an embodiment 7.

### EMBODIMENTS FOR CARRYING OUT THE INVENTION

In the following, an embodiment according to the present disclosure will be described while making reference to the drawings.

As an example of an image forming apparatus in the following description, it is possible to cite a copying machine, a printer, a multi-function machine, a commercial printing apparatus, and the like. The image forming apparatus forms an image on a recording medium on the basis of image information input from an external computer or image information read from an original. As the recording medium, sheet materials including various materials and various shapes, such as paper including plain paper, thick paper, and the like; a plastic film; special-shaped sheets such as coated paper, an envelope, and index paper; and a cloth; and the like materials are used.

### Embodiment 1

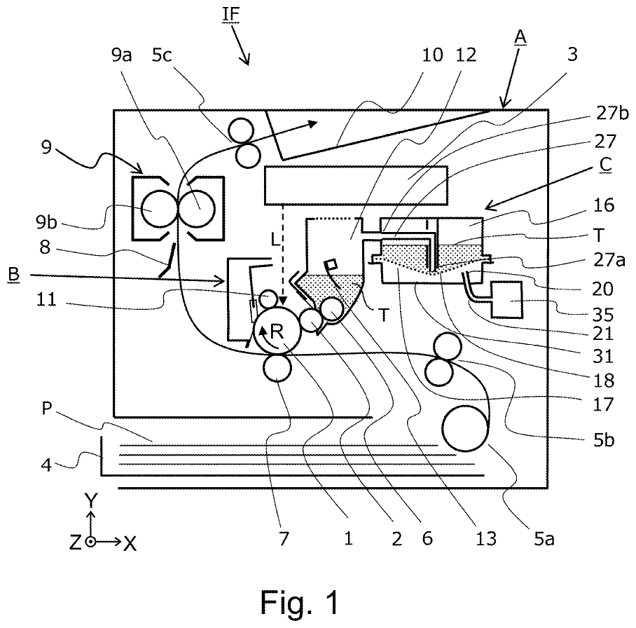

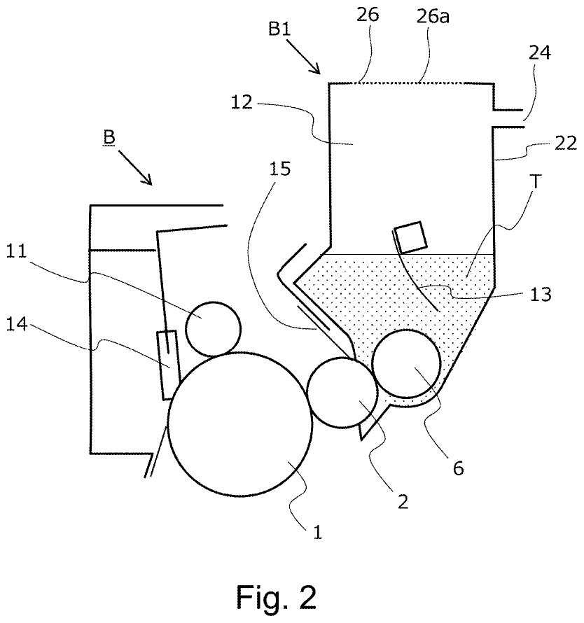

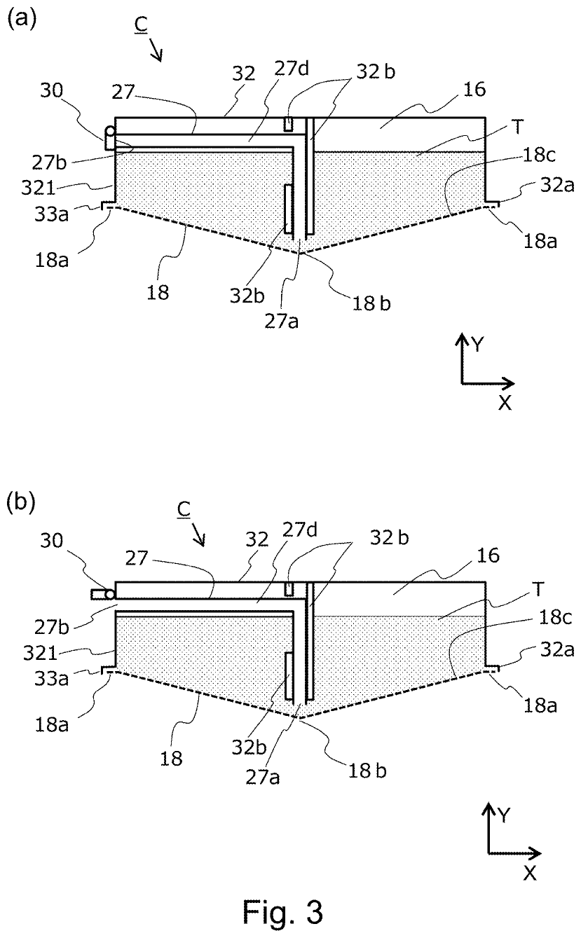

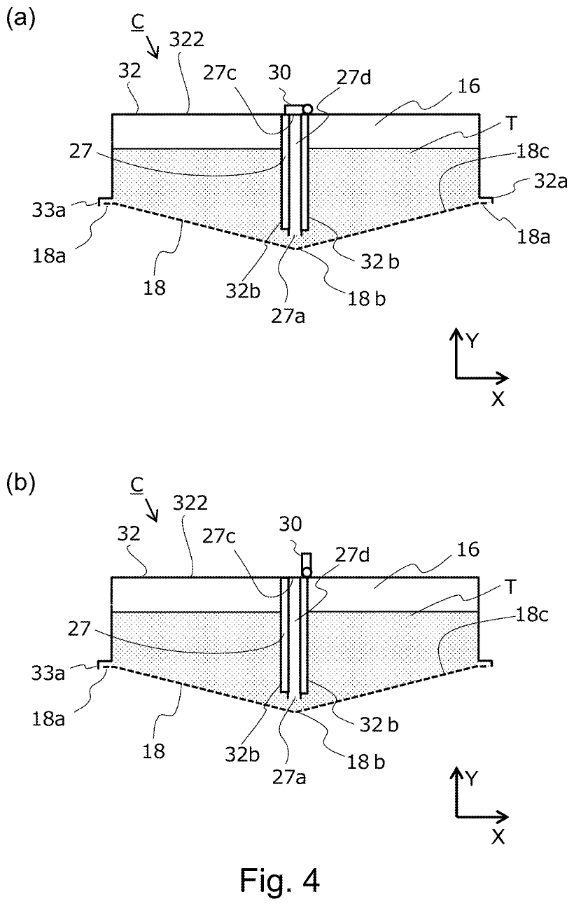

FIG. 1 is a schematic view showing a cross-sectional constitution of an image forming apparatus IF according to an embodiment 1. FIG. 2 is a schematic view showing a process cartridge B provided in the image forming apparatus IF.

As shown in FIG. 1, the image forming apparatus IF is provided with an apparatus main assembly A, the process cartridge B, and a toner cartridge C. The process cartridge B and the toner cartridge C are detachably mounted to the apparatus main assembly A. The apparatus main assembly A is a portion such that the process cartridge B and the toner cartridge C are excluded from the image forming apparatus IF. The image forming apparatus IF forms an image on a sheet P which is the recording medium by using an image forming means or the process cartridge B as a process unit.

### Constitution of Overall Image Forming Apparatus

As shown in FIG. 1, the image forming apparatus IF of this embodiment is a laser beam printer for forming an image on the sheet P by an electrophotographic process with use of a laser beam L and toner T as a developer.

The apparatus main assembly A is provided with a laser scanner 3 as an exposure means or an exposure unit, a transfer roller 7 as a transfer means or a transfer unit, and a fixing device 9 as a fixing means. Further, the apparatus main assembly A includes a sheet tray 4 as a sheet accommodating portion, a pick-up roller 5a as a feeding means or a feeding unit, a conveying roller pair 5b, a discharging roller pair 5c as a discharging means or a discharging unit, and a discharge tray 10 as a sheet stacking portion.

The apparatus main assembly A is provided with a sheet conveying path along which the sheet P is conveyed from the sheet tray 4 to the discharge tray 10. In a movement direction of the sheet P along the sheet conveying path, the sheet tray 4, the pick-up roller 5a, the conveying roller pair 5b, the transfer roller 7, the fixing device 9, the discharging roller pair Sc, and the discharge tray 10 are disposed in this order.

The fixing device 9 includes a heating roller 9a as a heating member (fixing member), a pressing roller 9b as a pressing member, and an unshown heat source. The pressing roller 9b contacts an outer surface of the heating roller 9a and forms a nip (image forming nip) in a cooperation with the heating roller 9a. As the heat source, it is possible to cite a ceramic heater such that a pattern of a heat generating resistor is printed on a ceramic substrate, a halogen lamp generating radiant heat, or a coil unit for causing an electroconductive layer in the heating roller 9a to generate heat on a principle of induction heating. Incidentally, as the heating member (fixing member), a cylindrical film member and an endless belt member stretched by a plurality of rollers may also be used.

As shown in FIG. 2, the process cartridge B includes a photosensitive drum 1 as a photosensitive member and a charging roller 11 as a charging means or a charging unit. The photosensitive drum 1 functions as an image bearing member for bearing a latent image and a toner image. The photosensitive drum 1 is a photosensitive member such that a photosensitive layer is formed of an organic photosensitive material or the like in an outer peripheral portion of a substrate molded in a drum shape (cylindrical shape).

Further, the process cartridge B includes a developing unit B1 as a developing means and a cleaning blade 14 as a cleaning means or a cleaning unit. The developing unit B1 includes a developing roller 2, a supplying roller 6, a toner chamber 12, a stirring member 13, and a developing blade 15. The developing roller 2 is a developer carrying member rotating while carrying the toner T as the developer and for supplying the toner T to the photosensitive drum 1. The supplying roller 6 is a supplying member for supplying the toner T to the developing roller 2. The toner chamber 12 is an accommodating portion (toner accommodating portion) in which the toner T is accommodated. The toner chamber 12 is formed inside a frame 22 of the developing unit B1. The stirring member 13 is disposed in the toner chamber 12, and is rotatable so as to stir and uniformize the toner T accommodated in the toner chamber 12. The developing blade 15 is a regulating member for regulating an amount of the toner T carried by the developing roller 2.

Each of the charging roller 11 for performing a charging process, the laser scanner 3 for performing an exposure process, the developing roller 2 for performing a developing process, and the transfer roller 7 for performing a transferring process is an example of a process means actable on the photosensitive drum 1 in the electrophotographic process. The process cartridge refers to one constituted by the photosensitive drum 1 and at least one process means actable on the photosensitive drum 1 as a unit integrally detachably mountable to the apparatus main assembly of the image forming apparatus.

Further, the process cartridge B includes a receiving port 24 for receiving the toner T supplied from the toner cartridge C, and a discharge portion 26 for discharging air in the toner chamber 12, to an outside of the toner chamber 12. The receiving port 24 is provided at an upper portion of a side wall of the frame 22 of the developing unit B1, and the discharge portion 26 is provided at an upper surface of the frame 22. The discharge portion 26 includes one or more openings (vent holes) formed at the upper surface of the frame 22 and a filter 26a mounted so as to cover the vent holes. The filter 26a is a sheet-like member (ventilation member) having air permeability and is, for example, a nonwoven fabric. The filter 26a permits passage of the air and prevents passage of the toner T.

The process cartridge B is supplied with the toner T from the toner cartridge C. The toner C will be described later.

### Flow of Image Forming Operation

A flow of a series of operations (image forming operation) in which the image forming apparatus IF forms an image on the sheet P while conveying the sheet P will be described. When the image forming apparatus IF receives image information and an instruction to start formation of the image on the sheet P, execution of the image forming operation is started by a controller mounted to the apparatus main assembly A.

When the image forming operation is started, the photosensitive drum 1 is a rotationally driven at a predetermined peripheral speed (process speed) in an arrow R direction of FIG. 1. The charging roller 11 electrically charges a surface of the photosensitive drum 1 to a uniform potential. The laser scanner 3 performs exposure by irradiating the photosensitive drum 1 with a laser beam L based on the image information, and writes an electrostatic latent image on the surface of the photosensitive drum 1.

The toner T accommodated in the toner chamber 12 is sent toward a sponge-shaped supplying roller 6 by the stirring member 13. The toner is supplied to the developing roller 2 by the supplying roller 6 and is carried on the surface of the developing roller 2, and is further formed in a thin layer on the surface of the developing roller 2 by the developing blade 15. The toner T is caused to reach a developing region, where the developing roller 2 and the photosensitive drum 1 oppose each other, by rotation of the developing roller 2. In the developing region, the toner T is transferred from the developing roller 2 onto the surface of the photosensitive drum 1 depending on a potential distribution of the surface of the photosensitive drum 1. By this, the electrostatic latent image on the surface of the photosensitive drum 1 is developed into the toner image.

In parallel to such processes, feeding of the sheet P is performed at a timing synchronized with the exposure process by the laser scanner 3. The pick-up roller 5a shown in FIG. 1 feeds the sheet P, stacked on the sheet tray 4, from the sheet tray 4. The conveying roller pair 5b receives the sheet P from the pick-up roller 5a and conveys the sheet P to a transfer portion formed between the photosensitive drum 1 and the transfer roller 7. Then, a bias voltage is applied to the transfer roller 7, whereby the toner image is transferred from the photosensitive drum 1 onto the sheet P.

The sheet P on which the toner image is transferred is conveyed to the fixing device 9 along a conveying guide 8. The fixing device 9 applies heat and pressure to the toner image on the sheet P while nipping and conveying the sheet P by the heating roller 9a and the pressing roller 9b. The sheet P on which the image is subjected to the fixing process is discharged and stacked onto the discharge tray 10 provided at an upper portion of the apparatus main assembly A.

### Toner Cartridge

By using part (a) of FIG. 3 to FIG. 11, the toner cartridge C according to the embodiment 1 will be described.

Parts (a) and (b) of FIG. 3 are sectional views of the toner cartridge C. Part (a) of FIG. 3 shows a state in which a shutter member 30 seals the discharge port 27b provided at a side surface of a cartridge frame 32. Part (b) of FIG. 3 shows a state in which the shutter member 30 opens the discharge port 27b.

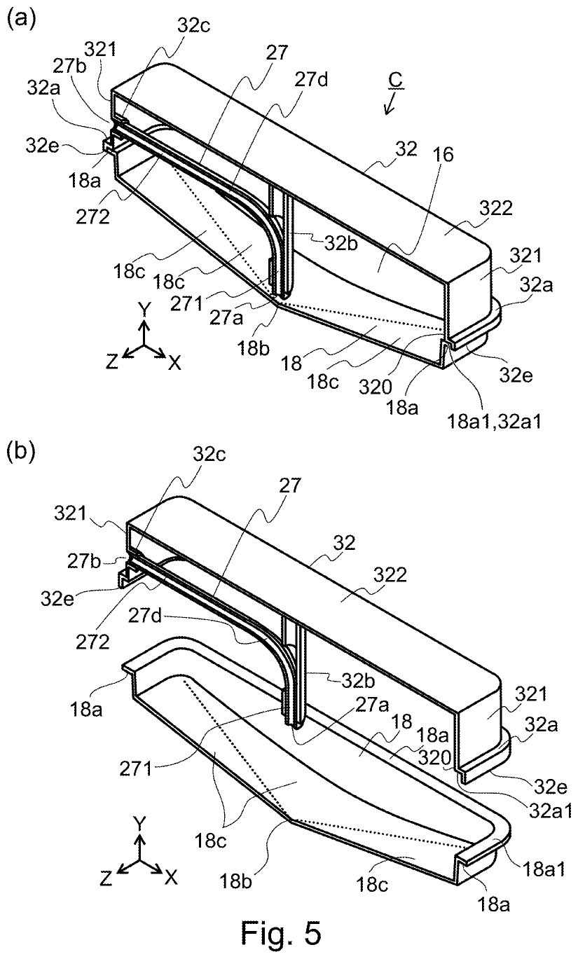

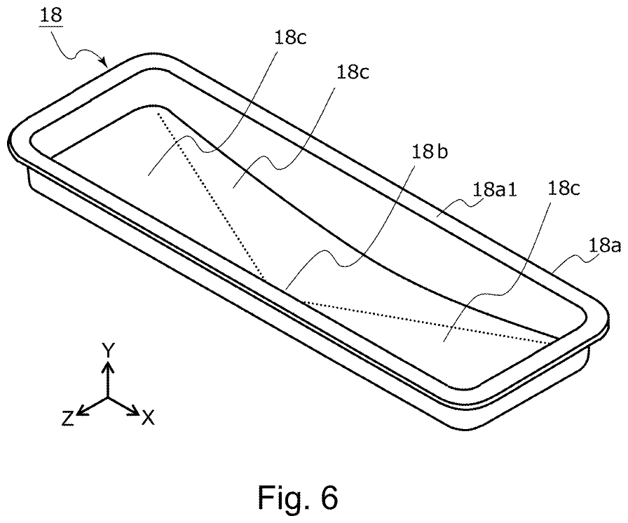

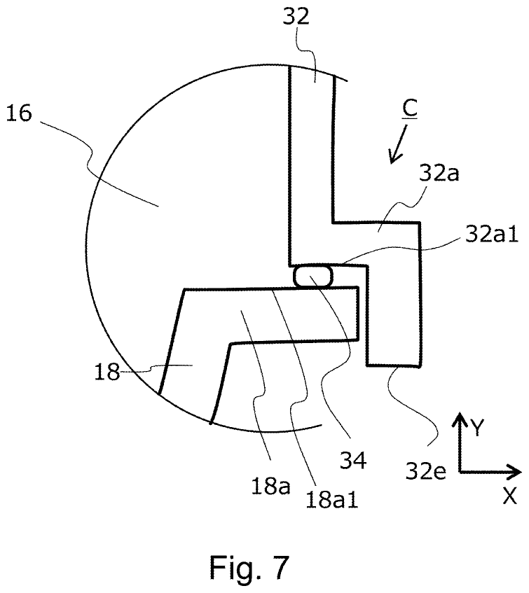

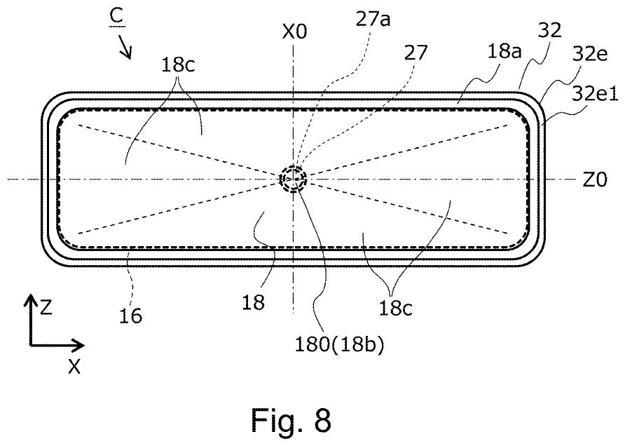

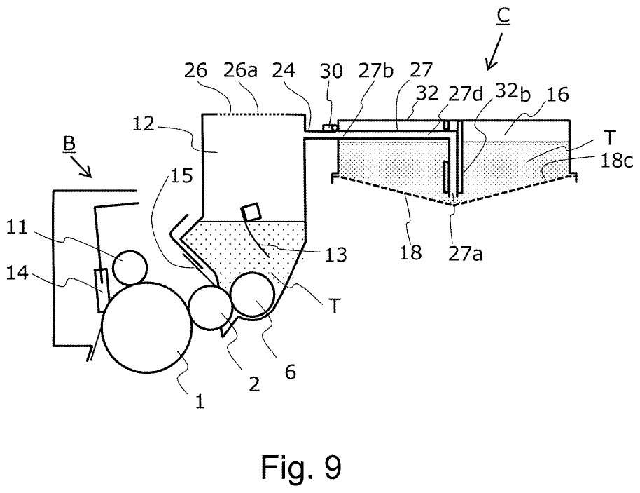

Part (a) of FIG. 5 is a cross-sectional perspective view when the toner cartridge C is cut along an X-Y plane in a center position of the toner cartridge C in a Z direction. Part (b) of FIG. 5 is a cross-sectional perspective view showing a partially exploded state of the toner cartridge C. FIG. 6 is perspective view of the filter 18. FIG. 7 is a partially sectional view showing a part (a bonding portion between the filter 18 and the cartridge frame 32) of the toner cartridge C. FIG. 8 is a top (plan) view of the toner cartridge C as viewed from a −Y side. FIG. 9 is a sectional view of the toner cartridge C and the process cartridge B.

In each of views of part (a) of FIG. 3 and later, it is assumed that the toner cartridge C is in an orientation when mounted to the apparatus main assembly A. Further, in each of the views of part (a) of FIG. 3 and later, an X direction, a Y direction, and the Z direction are defined as follows. The Y direction is a direction parallel to a vertical direction (gravitational direction). The X direction is a direction perpendicular to the Y direction and is a horizontal direction (left-right direction in FIG. 1) in FIG. 1. The Z direction is a direction perpendicular to both the X direction and the Y direction, and is a depth direction.

Further, as needed, in the X direction, a side indicated by an arrow “X” is referred to as a “+X side”, and an opposite side thereto is referred to as a −X side”. Similarly, in the Y direction, a side indicated by an arrow “Y” is referred to as a “+Y side”, and an opposite side thereof is referred to as a “−Y side”. In the Z direction, a side indicated by an arrow “Z” is referred to as a “+Z side”, and an opposite side thereto is referred to as a “−Z side”. The −Y side is a lower side (gravitational direction side) in the vertical direction, and the +Y side is an upper side (opposite side of the gravitational direction) in the vertical direction.

First, an overall constitution of the toner cartridge C will be described. As shown in part (a) of FIG. 3, the toner cartridge C includes the cartridge frame 32 (container frame), the filter 18, a discharge pipe 27, and the shutter member 30. The filter 18 is a sheet-like member (filter member, ventilation member) having air permeability. By the cartridge frame 32 and the filter 18, a toner accommodating chamber 16 which is an accommodating space (first chamber) for accommodating the toner T is formed.

That is, the cartridge frame 32 (container frame) and the filter 18 constitutes a container forming the first chamber for accommodating the toner. The toner accommodating chamber 16 is an inside space of the toner cartridge C. The filter 18 forms at least a part of a bottom of the toner accommodating chamber 16.

The discharge pipe 27 is mounted to the cartridge frame 32. The discharge pipe 27 forms a flow path 27d which is a space for communicating the toner accommodating chamber 16 and an outside space of the toner cartridge C with each other. The flow path 27d is a flow path along which the toner T flows from the toner accommodating chamber 16 toward an outside of the toner cartridge C.

As shown in parts (a) and (b) of FIG. 5, the cartridge frame 32 includes an upper surface 322 directed upward, a side surface 321 extending downward in the vertical direction (Y direction) from each of sides of an outer edge of the upper surface 322, and an opening 320 opened downward (−Y side). An edge portion (edge portion of the opening 320) opposing the filter 18 of the cartridge frame 32 is provided with a flange portion 32a as a supporting portion for supporting the filter 18. An area of the opening 320 (opening of the container frame, second opening) is larger than an area of the discharge port 27b (first opening) communicating with the outside of the toner cartridge C.

The filter 18 includes an outer edge portion 18a opposing the flange portion 32a of the cartridge frame 32. The outer edge portion 18a is formed in a flange shape extending toward a side, away from the toner accommodating chamber 16, from an upper end of a wall surface raised from an outer edge of a surface (inclined portion 18c described later), forming the bottom of the toner accommodating chamber 16, in a substantially vertically upward direction (+Y side). An end surface 32a1 of the flange portion 32a of the cartridge frame 32 on the −Y side and an end surface 18a1 of the outer edge portion 18a of the filter 18 on the +Y side oppose each other.

As viewed in the Y direction, the flange portion 32a of the cartridge frame 32 and the outer edge portion 18a of the filter 18 are provided so as to extend around the toner accommodating chamber 16 in one turn. Sides of each of the flange portion 32a and the outer edge portion 18a have a substantially rectangular shape including two sides each extending in the Z direction on the +X side and the −X side with respect to the toner accommodating chamber 16 and two sides each extending in the X direction on the +Z side and the −Z side with respect to the toner accommodating chamber 16.

The flange portion 32a and the outer edge portion 18a are bonded to each other, so that the opening 320 of the cartridge frame 32 is covered with the filter 18. By this, the toner accommodating chamber 16 as a space enclosed by the cartridge frame 32 and the filter 18 is formed. In this embodiment, the toner accommodating chamber 16 is continuous to an outside space of the toner cartridge C through pores of the filter 18 and the flow path 27d inside the discharge pipe 27.

The flange portion 32a and the outer edge portion 18a are bonded to each other so that the air and the toner are not leaked from a gap therebetween to the outside of the toner cartridge C. A bonding method between the flange portion 32a and the outer edge portion 18a is not particularly limited, but it is possible to select either one of, for example, ultrasonic welding, thermal welding, bonding with an adhesive such as a hot-melt adhesive, and mechanical bonding with screws or the like.

As shown in FIG. 7, the flange portion 32a and the outer edge portion 18a may also be bonded to each other in a state in which a seal portion 34 is sandwiched between end surfaces 18a1 and 32a1 of both thereof. By sealing the gap between the flange portion 32a and the outer edge portion 18a by the seal portion 34, the air and the toner can be made less likely to leak to the outside of the toner cartridge C. The seal portion 34 may be an annular member having flexibility), such as a silicone rubber, another rubber, or the like. Further, the seal portion 34 may also be, for example, an adhesive (hot-melt adhesive) for bonding the flange portion 32a and the outer edge portion 18a.

Incidentally, the outer edge portion 18a of the filter 18 may also have a shape such that a surface of the filter 18 forming the bottom of the toner accommodating chamber 16 is extended to an outer periphery side. Further, instead of a constitution in which the end surfaces of the cartridge frame 32 and the filter 18 opposing each other in the Y direction are bonded to each other, end surfaces opposing each other in a direction crossing the Y direction may be bonded to each other.

FIG. 8 shows a state in which the toner cartridge C is viewed in a vertically upward direction (+Y direction) in an orientation of the toner cartridge C when mounted to a mounting portion 31. In the orientation of the toner cartridge C when the toner cartridge C is mounted to the mounting portion 31, there is the opening 320 at the bottom of the cartridge frame 32, and the filter 18 covering the opening 320 constitutes a part of an outer surface of the toner cartridge C. In other words, in the case where the toner container takes a mounting orientation, the toner cartridge is constituted so that there is the second opening at the bottom of the container frame, and the filter constitutes a part of the outer surface of the toner container.

As shown in FIG. 8, when the toner cartridge C is viewed in the vertically upward direction (+Y direction), it is desirable that most of the filter 18 is exposed. “most” is i50% or more (½ or more), preferably 80% or more, more preferably 90% or more, of an area of the filter 18 when the toner cartridge C is viewed in the vertically upward direction (+Y direction). In this embodiment, a whole of the filter 18 is exposed when the toner cartridge C is viewed in the vertically upward direction (+Y direction).

Further, when the toner cartridge C is viewed in the vertically upward direction (+Y direction), it is preferred that a whole of a region in which of the filter 18, at least the bottom of the toner accommodating chamber 16 is formed is exposed. In this embodiment, the region in which of the filter 18, the bottom of the toner accommodating chamber 16 is formed is a whole of the inclined portion 18c and a lowermost portion 18b.

With a larger exposure area of the filter 18 when the toner cartridge C is viewed in the vertically upward direction (+Y direction), in the case where the toner cartridge C is mounted to the mounting portion 31, an exposure area of the filter 18 relative to an air chamber 17 described later becomes larger. For this reason, the toner is fluidized in a wider range of the bottom of the toner accommodating chamber 16, and the toner becomes less likely to stay at a corner portion of the toner accommodating chamber 16 when a remaining toner amount becomes small, or the like, so that discharge of the toner from the toner cartridge C can be more efficiently performed.

When the toner cartridge C is viewed in the vertically upward direction (+Y direction), it is preferred that at least a central portion 180 of the filter 18 is exposed. The central portion 180 of the filter 18 is a region including a point defined by center positions X0 and Z0 of the bottom of the toner accommodating chamber 16 in the X direction and the Z direction. In this embodiment, the central portion 180 of the filter 18 corresponds to the following lowermost portion 18b. Further, the central portion 180 (lowermost portion 18b) of the filter 18 is a portion opposing an inlet (inflow) port 27a of the discharge pipe 27 with respect to the vertical direction (Y direction).

As shown in FIG. 6, the filter 18 forms the bottom of the toner accommodating chamber 16. The filter 18 includes the inclined portion 18c inclined toward the lowermost portion 18b. That is, at least a part of the bottom of the toner accommodating chamber 16 is an inclined surface inclined with respect to a horizontal plane perpendicular to the vertical direction (Y direction). In other words, the inclined portion of the filter member is inclined so that of the filter member, a portion opposing the inlet port in the vertical direction becomes the lowermost portion and so that a height of the filter member in the vertical direction becomes lower as the inclined portion approaches the lowermost portion in a direction in the horizontal plane perpendicular to the vertical direction. By the inclined portion 18c, as described later, it becomes possible that the toner in the toner accommodating chamber 16 is discharged more efficiently.

The filter 18 is formed of a material which permits passage of the air and which prevents passage of the toner T. The filter 18 is formed of, for example, a sheet material which is a porous sheet material comprising resin fibers and which has a size and a density such that the passage of the air is permitted and the passage of the toner T is prevented. As the filter 18, for example, a nonwoven fabric can be used. Further, a filter material molded by heat-pressing, sintering, or the like may also be used.

The discharge pipe 27 will be described. As shown in part (a) of FIG. 5, the discharge pipe 27 is a cylindrical member (hollow member) communicating the toner accommodating chamber 16 and the outside of the toner cartridge C with each other. Through the flow path 27d which is an inside space of the discharge pipe 27, the toner accommodating chamber 16 which is an inside space of the toner cartridge C and an outside space of the toner cartridge C are continuous to each other.

One end of the discharge pipe 27 is the inlet port 27a provided in the toner accommodating chamber 16. The other end of the discharge pipe 27 is the discharge port 27b provided at an outer surface of the toner cartridge C. As the discharge pipe 27, a tube made of a flexible material such as silicone rubber or another rubber, or a pipe made of synthetic resin or metal, may be used.

In this embodiment, the inlet port 27a is open downward (toward −Y side) in the vertical direction. The discharge port 27b is provided at the side surface 321 of the cartridge frame 32 in a direction (X direction in this embodiment) crossing the vertical direction.

The inlet port 27a is provided in the neighborhood of the lowermost portion 18b of the filter 18. The discharge port 27b is disposed in a position higher than the inlet port 27a in the vertical direction (Y direction). That is, the discharge pipe 27 extends from a first position toward a second position higher than the first position in the vertical direction (Y direction).

As shown in part (a) of FIG. 3, the discharge port 27b is provided with the shutter member 30 (sealing member). The shutter member 30 is movable (openable and closable) between a closed position where the shutter member 30 closes the discharge port 27b and an open position where the shutter member 30 opens the discharge port 27b.

In a state (state of a single member) in which the toner cartridge C is not mounted to the apparatus main assembly A, the shutter member 30 is in the closed position. In this case, the shutter member 30 seals the discharge port 27b, so that the toner in the toner accommodating chamber 16 is prevented from being leaked out to the outside of the toner cartridge C.

When the toner cartridge C is mounted to the apparatus main assembly A, as shown in part (b) of FIG. 3, the shutter member 30 is moved from the closed position to the open position. By this, discharge of the toner T from the toner cartridge C is permitted. Further, in a state in which the toner cartridge C is mounted to the apparatus main assembly A, as shown in FIG. 9, the discharge port 27b and the receiving port 24 of the process cartridge B communicate with each other. By this, the toner cartridge C and the process cartridge B become a state in which the toner T in the toner accommodating chamber 16 can be supplied to the process cartridge B. Incidentally, a constitution in which the discharge port 27b of the toner cartridge C and the receiving port 24 of the process cartridge B are connected through a path (for example, see a relay pipe 225 in an embodiment 5) provided in the apparatus main assembly A may also be employed.

Here, as shown in parts (a) and (b) of FIG. 4 as a modified embodiment, the discharge port 27b and the shutter member 30 may also be provided at the upper surface 322 of the cartridge frame 32. Part (a) of FIG. 4 shows a state in which the shutter member 30 seals a discharge port 27c provided at the upper surface 322 of the cartridge frame 32. Part (b) of FIG. 4 shows a state in which the shutter member 30 opens the discharge port 27c. In the case of this modified embodiment, the receiving port 24 of the process cartridge B is appropriately moved from a position in the embodiment 1 (FIG. 9) to a position corresponding to the discharge port 27c.

The toner accommodating chamber 16 will be described. As shown in part (a) of FIG. 3, the toner accommodating chamber 16 is a space enclosed by the cartridge frame 32 and the filter 18. The cartridge frame 32 forms a wall surface (ceiling surface) on an upper side (+Y side) of the toner accommodating chamber 16 and wall surfaces on the +X side, the −X side, the +Z side, and the −Z side of the toner accommodating chamber 16. The filter 18 forms a wall surface (bottom) on a lower side (−Y side) of the toner accommodating chamber 16.

As shown in parts (a) and (b) of FIG. 5, to the cartridge frame 32, an inlet port supporting portion 32b for supporting the discharge pipe 27 is mounted. The inlet port supporting portion 32b extends substantially vertically downward (−Y side) from the upper surface 322 of the cartridge frame 32 and is connected to the neighborhood of the inlet port 27a of the discharge pipe 27. Specifically, the discharge pipe 27 includes a first portion 271 extending substantially vertically upward (+Y side) from the inlet port 27a, and a second portion 272 extending from the side surface 321 which is an end surface of the cartridge frame 32 toward an inside of the toner accommodating chamber 16 on the +X side. A lower portion of the inlet port supporting portion 32b is connected to the first portion 271 of the discharge pipe 27. The inlet port supporting portion 32b supports the first portion 271 of the discharge pipe 27, so that the inlet port supporting portion 32b suppress positional deviation of the inlet port 27a relative to the cartridge frame 32.

Incidentally, the first portion 271 and a second portion 272 of the discharge pipe 27 are connected through a curved portion which is smoothly curved. Further, it is preferred that the inlet port 27a and the inlet port supporting portion 32b are in positions overlapping with the lowermost portion 18b of the filter 18 when viewed in the vertical direction (Y direction), for example. The second portion 272 which is a portion on the discharge port 27b side of the discharge pipe 27 is engaged into and held by a hole portion 32c provided in the side surface 321 of the cartridge frame 32.

The discharge pipe 27 and the inlet port supporting portion 32b may be formed integrally with the cartridge frame 32 or each may also be a separate member from the cartridge frame 32. The discharge pipe 27 and the inlet port supporting portion 32b may be formed integrally with each other or may also be different members from each other.

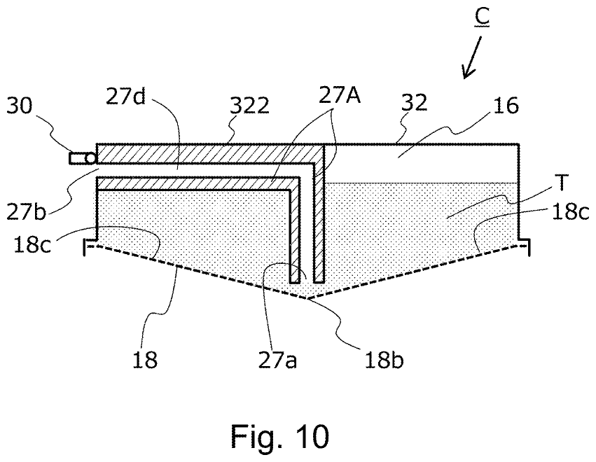

FIG. 10 is an illustration showing a modified embodiment relating to a discharge pipe and a supporting portion. A discharge pipe 27A in this modified embodiment is formed by a single member formed integrally with the upper surface 322 of the cartridge frame 32. The discharge pipe 27A has functions of both the discharge pipe 27, in the embodiment 1 forming the flow path 27d of the toner T, and the inlet port supporting portion 32b, in the embodiment 1, supporting the flow path.

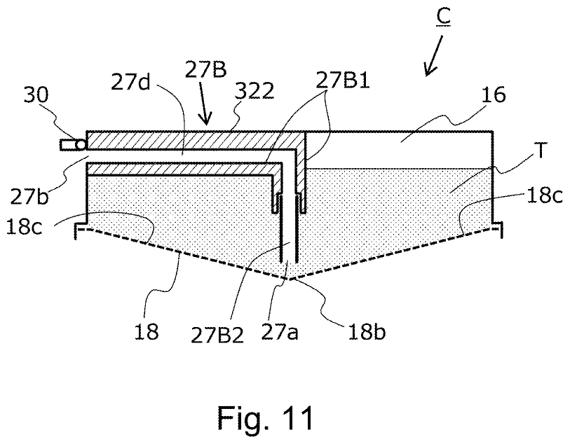

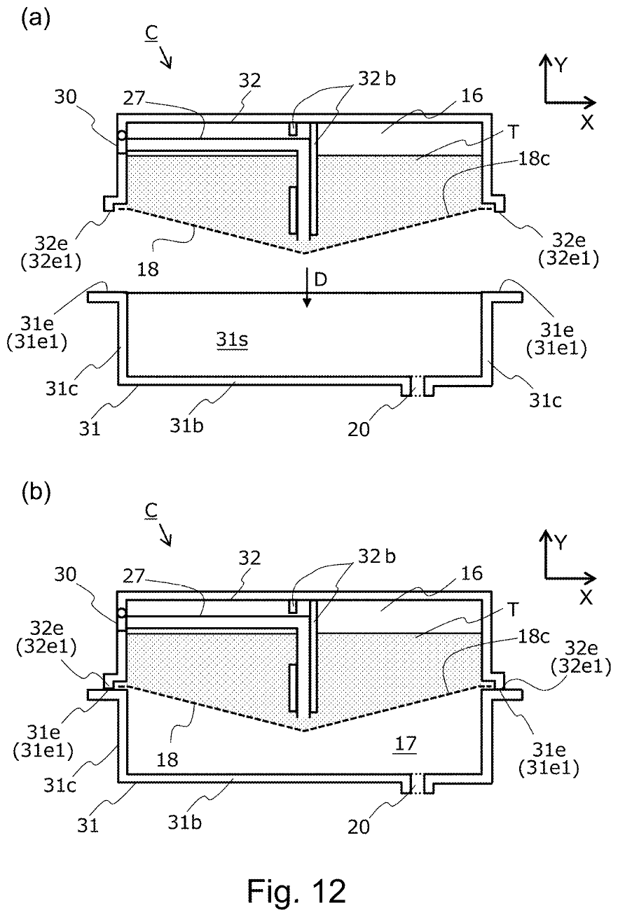

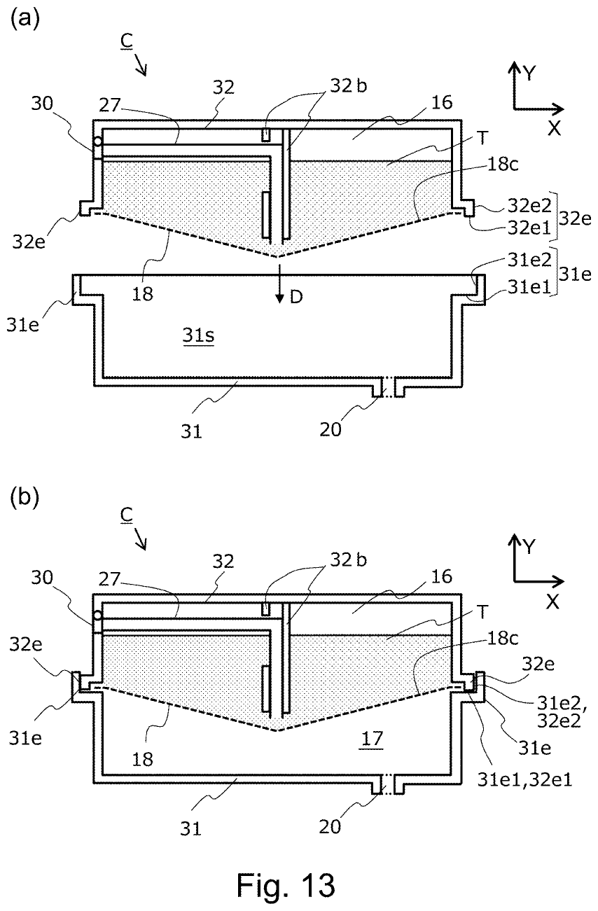

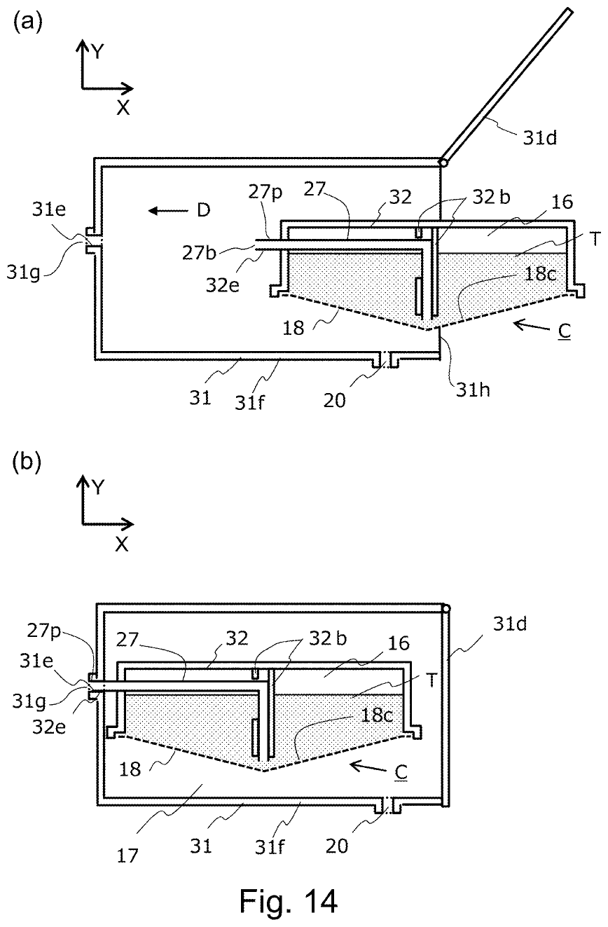

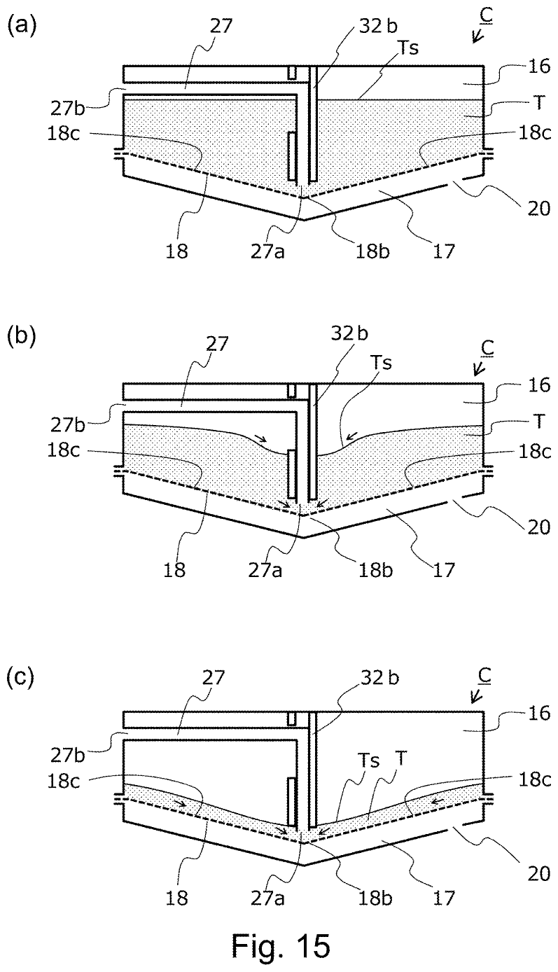

FIG. 11 is an illustration showing another modified embodiment relating to the discharge pipe and the supporting portion. In this modified embodiment, a discharge pipe 27B includes a first member 27B1 and a second member 27B2. One end of the first member 27B1 is provided with the inlet port 27a. The second member 27B2 is formed integrally with the upper surface 322 of the cartridge frame 32 and is provided with the discharge port 27b at one end. The second member 27B2 is mounted to the first member 27B1 so that the other end of the first member 27B1 and the other end of the second member 27B2 communicate with each other. The second member 27B2 has function of the discharge pipe 27, in the embodiment 1, forming a part of the flow path 27d of the toner T and a function of the inlet port supporting portion 32b, in the embodiment 1, supporting the flow path. The first member 27B1 forms another part of the flow path 27d.

Thus, in this embodiment, a path along which the air is discharged to the outside of the toner cartridge C in the case where the air flows from the outside of the toner cartridge C into the toner accommodating chamber 16 through the filter 18 is only the flow path 27d formed by the discharge pipe 27. An advantage of this constitution will be described later.

### Mechanism of Toner Discharge

Next, a mechanism in which the toner T is discharged from the toner cartridge C and is supplied to the process cartridge B will be described using FIG. 1 and FIG. 9.

In this embodiment, by a force of compressed air discharged by a pump 35 provided in the apparatus main assembly A, supply of the toner T from the toner cartridge C to the process cartridge B is performed. It is also possible to use a power source other than the pump 35. In this embodiment, work (mechanism (dynamic) work) for discharging the toner T from the toner cartridge C is realized by using only pressure of the air discharged by the pump 35. In this embodiment, the discharge port 27b is not connected to a pump (powder pump, air pump, or the like) for sucking the toner T from the toner cartridge C. Further, in this embodiment, except for unavoidable leakage of the air leaked from a gap between a contact portion 32e and a contacted portion 31e which are described later, air in an amount equal to that of air supplied from the pump 35 to the air chamber 17 described later is discharged from the discharge port 27b.

As shown in FIG. 1, the apparatus main assembly A includes the pump 35 (air pump) as an air supplying portion or a supply means for supplying the air to the air chamber 17 described later, an air supply port 20 supplied with the air from the pump 35, and an air supply pipe 21 connecting the pump 35 and the air supply port 20. The pump 35 (air pump) may also be either one of, for example, a reciprocating pump, a diagram pump, or a rotary pump. Incidentally, for example, a fan may also be used as the supplying means.

Incidentally, the “air” supplied from the supplying means is not required to be the same constitution as that of ambient air. For example, the pump 35 may also be constituted so as to supply air, obtained by dehumidifying the ambient air, to the air chamber 17.

Further, the apparatus main assembly A includes the mounting portion 31 (cartridge installation portion, cartridge interface portion) to which the toner cartridge C is mounted. In a state in which the toner cartridge C is mounted to the apparatus main assembly A, the air chamber 17 which is a space enclosed by the toner cartridge C and the mount portion 31. The air supply port 20 opens to the air chamber 17. The air supply port 20 is an intake port for taking the air, from the pump 35 (air pump), into the air chamber 17 (second chamber).

In the state in which the toner cartridge C is mounted to the apparatus main assembly A, the filter 18 is exposed to the air chamber 17. Specifically, of the filter 18, at least a whole of a region forming the bottom of the toner accommodating chamber 16 is exposed to the air chamber 17. That is, in the state in which the toner cartridge C is mounted to the apparatus main assembly A, at least a part of a ceiling surface of the air chamber 17 is formed by the filter 18 of the toner cartridge C. Thus, the air chamber 17 which is the space enclosed by the toner cartridge C and the mounting portion 31 is formed, and the filter 18 is exposed to the air chamber 17, so that the toner cartridge C becomes a state in which the toner cartridge C is capable of discharging the toner by the supply of the air from the pump 35.

Specifically, the compressed air discharged by the pump 35 is supplied to the air chamber 17 through the air supply port 20. The air chamber 17 is a substantially closed space except for the air supply port 20 and pores of the filter 18, and therefore, air pressure (internal pressure) in the air chamber 17 increased by the air from the pump 35. When the air pressure in the air chamber 17 is increased, the air flows into the toner accommodating chamber 16 through the filter 18.

The air flowing in the toner accommodating chamber 16 fluidizes the toner T in the toner accommodating chamber 16. Then, the air mixed with the toner T flows from the inlet port 27a into the flow path 27d of the discharge pipe 27 and passes through the discharge port 27b, and is discharged to the outside of the toner cartridge C. Then, the air mixed with the toner T flows into the toner chamber 12 in the process cartridge B through the receiving port 24 of the process cartridge B connected to the discharge port 27b. Incidentally, in this embodiment, the toner T in the toner accommodating chamber 16 can be fluidized by the air, and therefore, a stirring member for stirring the toner T is not disposed in the toner accommodating chamber 16.

As shown in FIG. 9, to the process cartridge B, the above-described discharge portion 26 (FIG. 9) communicating the toner chamber 12 in the process cartridge B and the outside of the process cartridge B with each other is provided, and internal pressure of the toner chamber 12 is equal to ambient (atmospheric) pressure in general. For this reason, when the internal pressures of the air chamber 17 and the toner accommodating chamber 16 are increased by the air supplied from the pump 35, the internal pressure of the toner accommodating chamber 16 becomes higher than the internal pressure of the toner chamber 12. For this reason, the air mixed with the toner T is moved from the toner accommodating chamber 16 to the toner chamber 12 through the discharge pipe 27.

When the air mixed with the toner T flows into the toner chamber 12, the internal pressure of the toner chamber 12 is temporarily increased. However, the discharge portion 26 is capable of discharging the air inside the toner chamber 12 to the outside of the process cartridge B, and therefore the internal pressure of the toner chamber 12 lowers. In this embodiment, after the internal pressure of the toner chamber 12 is temporarily increased, the internal pressure of the toner chamber 12 quickly lowers to a value substantially equal to the ambient pressure.

Here, as described above, a path along which the air is discharged to the outside of the toner cartridge C in the case where the air flows into the toner accommodating chamber 16 from the outside of the toner cartridge C through the filter 18 is only the flow path 27d formed by the discharge pipe 27. For this reason, when the air flows into the toner accommodating chamber 16 from the air chamber 17 through the filter 18, the air is discharged to the outside of the toner cartridge C exclusively through the discharge pipe 27.

Thus, an outlet of the air in the toner cartridge is made one place which the discharge pipe 27 (discharge port 27b), so that the flow of the air is stabilized. For this reason, the toner T in the toner accommodating chamber 16 can be more stably discharged to the outside of the toner cartridge C.

Further, compared with a comparison constitution in which the toner T is conveyed by using both a pump for discharging the air for fluidizing the toner T and a pump for sucking the air mixed with the toner T, in this embodiment, the latter pump is not needed. For this reason, compared with the above-described comparison constitution, in a simple constitution, it becomes possible to discharge the toner from the toner cartridge C.

Incidentally, in this embodiment, although an example in which the pump 35 is provided in the apparatus main assembly A was described, but the pump 35 may also be mounted to the process cartridge B or the toner cartridge C.

### Connecting Portion between Apparatus Main Assembly and Toner Cartridge

Next, a constitution of a connecting portion between the apparatus main assembly A and the toner cartridge C will be described using FIG. 7, FIG. 8, and parts (a) and (b) of FIG. 12.

Parts (a) and (b) of FIG. 12 are sectional views showing the mounting portion 31 provided in the apparatus main assembly A, and the toner cartridge C. Part (a) of FIG. 12 shows a state before the toner cartridge C is mounted to the mounting portion 31. Part (b) of FIG. 12 shows a state in which the toner cartridge C is mounted to the mounting portion 31.

As shown in part (a) of FIG. 12, the toner cartridge C includes the contact portion 32e. The mounting portion 31 includes the contacted portion 31e and the above-described air supply port 20. The contact portion 32e is provided so as to surround a periphery of the filter 18 in the case where the toner cartridge C is viewed in the vertically upward direction. In other words, the above-described frame includes the contact portion provided so as to surround the periphery of the filter member in the case where the cartridge is viewed in the vertically upward direction in an orientation of the cartridge when the cartridge is mounted to the mounting portion. Further, the contact portion 32e is an annular surface provided so as to surround the periphery of the filter 18 in the case where the toner cartridge C is viewed in the vertically upward direction. “annular” is not limited to a ring shape, but is a belt-shaped region formed between two closed curves which do not cross each other on an object surface. In other words, the frame includes the annular surface provided so as to surround the filter member in the case where the cartridge is viewed in the vertically upward direction in the above-described orientation of the cartridge such that the filter member becomes the above-described bottom of the above-described accommodating space.

In the case where the toner cartridge C is mounted to the mounting portion 31, the contact portion 32e contacts the contacted portion 31e. By contact between the contact portion 32e and the contacted portion 31e, the air chamber 17 is formed as a space enclosed by the toner cartridge C and the mounting portion 31. Then, the air from the pump 35 is supplied to the air chamber 17 through the air supply port 20, so that the toner supply from the toner cartridge C to the process cartridge B is performed as described above.

The contact portion 32e and the contacted portion 31e in this embodiment will be specifically described. As shown in part (a) of FIG. 12, in this embodiment, the toner cartridge C is mounted to the mounting portion 31 by being moved and operated from an upward side (+Y side) of the mounting portion 31 in a downward mounting direction (arrow D) in the vertical direction.

The contact portion 32e is provided to the cartridge frame 32. The contact portion 32e extends from an outside end of the flange portion 32a toward the −Y side (see also FIG. 7). The contact portion 32e projects downward (−Y side) in the vertical direction than the outer edge portion 18a of the filter 18 bonded to the flange portion 32a. For this reason, the contact between the contact portion 32e and the contacted portion 31e can be made less likely to be prevented by the outer edge portion 18a of the filter 18.

As shown in FIG. 8, the contact portion 32e is provided over a full-circumference of the cartridge frame 32. That is, when the toner cartridge C is viewed in the Y direction, the contact portion 32e is provided so as to surround an outer peripheral side of an exposed portion of the filter 18 over a full-circumference of the exposed portion. In other words, when the toner cartridge C is viewed in the Y direction, the contact portion 32e has a closed curve shape and the filter 18 is exposed on an inside of a region enclosed by the contact portion 32e, and the filter 18 is not exposed on an outside of the region enclosed by the contact portion 32e.

In this embodiment, the contact portion 32e includes an end surface 32e1 of the cartridge frame 32 on the −Y side. The contact portion 32e in this embodiment is formed in a flat surface shaped equal in height in the Y direction over the full circumference thereof. That is, a whole of the contact portion 32e is provided on the same virtual flat plane (on an X-Z flat plane) perpendicular to the Y direction.

The contacted portion 31e is provided over a full circumference of a periphery of the air chamber 17 correspondingly to the contact portion 32e of the toner cartridge C when the contacted portion 31e is viewed in the Y direction. As shown in part (a) and (b) of FIG. 12, the mounting portion 31 has a recessed shape which is open toward an opposite side to the mounting direction (arrow D) of the toner cartridge C. The mounting portion 31 includes a bottom wall portion 31b including an opposing surface opposing the filter 18 with an interval in the Y direction in the case where the toner cartridge C is mounted to the mounting portion 31 and includes a side wall portion 31c extending from an outer periphery of the bottom wall portion 31b toward the +Y side. The side wall portion 31c is a side wall provided at a periphery of the filter 18 when viewed in the gravitational direction and extends upward from the bottom wall portion 31b. To the bottom wall portion 31b or the side wall portion 31c (in this embodiment, the bottom wall portion 31b), the air supply port 20 (intake port) is provided. The contacted portion 31e is provided at an end portion of the side wall portion 31c on the +Y side.

The contacted portion 31e is provided over a full circumference of a periphery of a space 31s inside the bottom wall portion 31b and the side wall portion 31c of the mounting portion 31 when the contacted portion 31e is viewed in the Y direction. When the mounting portion 31 is viewed in the Y direction, the contacted portion 31e has a closed curve shape, and the space 31s which is opened toward the +Y side is formed inside a region enclosed by the contacted portion 31e (part (a) of FIG. 12).

The contacted portion 31e includes an end surface 31e1 of the mounting portion 31 on the +Y side. The contacted portion 31e in this embodiment is formed in a flat surface shape equal in height in the Y direction over the full circumference thereof. That is, a whole of the contacted portion 31e is provided on the same virtual flat plane (on an X-Z flat plane) perpendicular to the Y direction.

In the case where the toner cartridge C is mounted to the mounting portion 31, the filter 18 of the toner cartridge C covers the space 31s inside the mounting portion 31 from the +Y side. By this, the air chamber 17 as a substantially closed space excluding the air supply port 20 and the pores of the filter 18 is formed (part (b) of FIG. 12). In this embodiment, an upper portion of the mounting portion 31 which is a recessed shape toward a lower side (−Y side) in the vertical direction is closed by the toner cartridge C (particularly, by the filter 18), so that the air chamber 17 is formed inside the recessed shape. In other words, the bottom wall portion 31b (bottom wall) and the side wall portion 31c (side wall) function as a wall portion constituted so as to form the air chamber 17 (second chamber) with the filter 18 as an upper surface in the state in which the toner cartridge C is mounted to the mounting portion 31. In this embodiment, the air chamber 17 is enclosed by the filter 18, the bottom wall portion 31b, and the side wall portion 31c.

Incidentally, the discharge port 27b of the toner cartridge C is positioned outside the air chamber 17 formed between the toner cartridge C and the mounting portion 31. For this reason, in the case where the toner cartridge C is mounted to the mounting portion 31. For this reason, in the case where the toner cartridge C is mounted to the mounting portion 31, it becomes possible to connect the discharge port 27b and the receiving port 24 (FIG. 9) of the process cartridge B with each other without being prevented by the mounting portion 31.

Parts (a) and (b) of FIG. 13 are sectional views of a toner cartridge C and a mounting portion 31 according to a modified embodiment. A contact portion 32e in this modified embodiment includes a downstream-side end surface 32e1 of a cartridge frame 32 in the mounting direction (arrow D) of the toner cartridge C and includes an end surface 32e2 directed to the outside of the toner cartridge C in directions (X direction, Z direction) crossing the mounting direction (arrow D). Further, a contacted portion 31e in this modified embodiment includes an upstream-side end surface 31e1 of the mounting portion 31 in the mounting direction (arrow D) of the toner cartridge C and includes an end surface 31e2 directed to an inside in the directions (X direction, Z direction) crossing the mounting direction (arrow D).

The end surfaces 31e1 and 32e1 are, similarly as in the embodiment 1, formed over a full circumference of a periphery of an air chamber 17 and formed in a flat surface shape perpendicular to the Y direction. The end surfaces 31e2 and 32e2 are formed over the full circumference of the periphery of the air chamber 17 when viewed in the Y direction. Each of the end surfaces 31e2 and 32e2 has a shape (rectangular shape in this embodiment) corresponding to an outer configuration of the toner cartridge C when viewed in the Y direction. A width in the X direction and a width in the Z direction of a rectangle formed by the end surface 31e2 are substantially equal to a width in the X direction and a width in the Z direction, respectively, of a rectangle formed by the end surface 32e2.

As viewed in a direction (for example, the X direction, the Z direction) crossing the mounting direction (arrow D), the end surface 32e2 of the contact portion 32e and the end surface 31e2 of the contacted portion 31e at least partially overlap with each other.

In the state in which the toner cartridge C is mounted to the mounting portion 31, the end surface 32e1 of the toner cartridge C and the end surface 31e1 of the mounting portion 31 contact each other, and the end surface 32e2 of the toner cartridge C and the end surface 31e2 of the mounting portion 31 contact each other. By this, between the toner cartridge C and the mounting portion 31, the air chamber 17 is formed (part (b) of FIG. 12). The end surface 31e2 and the end surface 32e2 may have a relationship such that the inside end surface 32e2 is press-fitted in the outside end surface 31e2 so as to more easily reduce leakage of the air.

According to this modified embodiment, compared with the embodiment 1, the air can be made less likely to leak out from the air chamber 17. Incidentally, an embodiment in which only the end surface 32e1 of the toner cartridge C and the end surface 31e1 of the mounting portion 31 contact each other or only the end surface 32e2 of the toner cartridge C and the end surface 31e2 of the mounting portion 31 contact each other may also be employed.

Parts (a) and (b) of FIG. 14 are sectional views of a toner cartridge C and a mounting portion 31 according to another modified embodiment. The mounting portion 31 of this modified embodiment includes a cartridge accommodating portion 31f including an opening 31h on a side opposite to a mounting direction (arrow D) of the toner cartridge C and a lid portion 31d for opening and closing the opening 31h. The toner cartridge C is detachably mountable to the cartridge accommodating portion 31f through the opening 31h in a state (part (a) of FIG. 14) in which the lid portion 31d is opened.

The cartridge accommodating portion 31f is provided with a hole 31g penetrating from an inside to an outside of the cartridge accommodating portion 31f. Further, an end (discharge port 27b) of the discharge pipe 27 of the toner cartridge C projects in the mounting direction (arrow D) relative to an outer surface of the cartridge frame 32. In a state in which the toner cartridge C is mounted to the mounted state, a projected portion 27p of the discharge pipe 27 is inserted into a hole 31g of the cartridge accommodating portion 31f (part (b) of FIG. 14). By this, connection of the discharge port 27b with the receiving port 24 (FIG. 9) of the process cartridge B on an outside of the cartridge accommodating portion 31f is permitted.

The toner cartridge C includes a contact portion 32e, and the mounting portion 31 includes a contacted portion 31e. In this modified embodiment, the contact portion 32e is an outer peripheral surface of the projected portion 27p of the discharge pipe 27, and the contacted portion 31e is an inner peripheral surface of the hole 31g.

When the toner cartridge C is inserted into the cartridge accommodating portion 31f, the contact portion 32e and the contacted portion 31e contact each other. Then, when the lid portion 31d is closed, an air chamber 17 as a space enclosed by the toner cartridge C and the mounting portion 31 is formed. The air chamber 17 in this modified embodiment is formed by an inner in which the cartridge accommodating portion 31f, an inner wall of the lid portion 31d, a surface of the filter 18, and a surface of the cartridge frame 32.

### Advantage of Connecting Portion

In a constitution of this embodiment shown in FIG. 12, the contact portion 32e is a surface directed in the mounting direction (arrow D), and the contacted portion 31e is a surface directed toward a side opposite to the mounting direction (arrow D). For this reason, by an operation for moving the toner cartridge C in the mounting direction (arrow D), the contact portion 32e can be contacted to the contacted portion 31e.

A contact region between the contact portion 32e and the contacted portion 31e is provided in an annular shape (circumferential shape, closed curve shape). For this reason, when the contact portion 32e and the contacted portion 31e contact each other, the air chamber 17 which is the space enclosed by the toner cartridge C and the mounting portion 31 becomes a substantially closed space except for the air supply port 20 and the pores of the filter 18. For this reason, when the air is supplied from the air supply port 20 to the air chamber 17, internal pressure of the air chamber 17 increases. Then, the air flows from the air chamber 17 into the toner accommodating chamber 16 through the filter 18, so that the toner T discharged from the toner cartridge C by the above-described mechanism.

In other words, in the state in which the toner cartridge C is mounted to the mounting portion 31. A path of the air from the air chamber 17 to the discharge port 27b through the filter 18, the toner accommodating chamber 16, and the discharge pipe 27 is formed. In order to appropriately form the path of the air, it is desirable that the toner cartridge C and the mounting portion 31 contact each other in the annular contact region and that the filter 18 is in a region which is a region, of the surface of the toner cartridge C, on one side with respect to the annular contact region and which is exposed to the air chamber 17. Further, in order to appropriately form the path of the air, it is desirable that the discharge port 27b is in a region of the surface of the toner cartridge C, on the other side with respect to the annular contact region.

In the embodiment 1, a region in which the contact portion 32e and the contacted portion 31e contact each other corresponds to the above-described annular contact region. For this reason, the toner cartridge C and the mounting portion 31 can appropriately form the path of the air passing from the air chamber 17 through the filter 18, the toner accommodating chamber 16, the discharge pipe 27, and the discharge port 27b.

In the modified embodiment shown in parts (a) and (b) of FIG. 14, a region in which the contact portion 32e provided to the discharge pipe 27 and the contacted portion 31e provided to the hole 31g of the mounting portion 31 corresponds to the above-described annular contact region. For this reason, even in a constitution of this modified embodiment, the toner cartridge C and the mounting portion 31 can appropriately form the path of the air passing from the air chamber 17 through the filter 18, the toner accommodating chamber 16, the discharge pipe 27, and the discharge port 27b.

In order to prevent the air from leaking out from a gap between the contact portion 32e and the contacted portion 31e, it is desirable that the contact portion 32e and the contacted portion 31e hermetically contact each other over a full circumference. For that reason, an urging member for urging the toner cartridge C to the mounting portion 31 in the mounting direction (arrow D) so as to press the contact portion 32e to the contacted portion 31e may also be provided. Further, an urging member for urging the mounting portion 31, to the toner cartridge C, toward a side opposite to the mounting direction (arrow D) so as to press the contacted portion 31e to the contact portion 32e may also be provided. The urging member may also be provided to either one of the toner cartridge C and the apparatus main assembly A. The urging member may be an elastic member, such as a spring or a rubber, provided to the toner cartridge C so as to contact the apparatus main assembly A during mounting of the toner cartridge C toward the apparatus main assembly A, for example. Further, the urging member may also be magnet.

Incidentally, in the modified embodiment shown in parts (a) and (b) of FIG. 14, compared with the embodiment shown in parts (a) and (b) of FIG. 12 and the modified embodiment shown in parts (a) and (b) of FIG. 13, a peripheral length of the contact portion between the contact portion 32e and the contacted portion 31e is short. For this reason, for example, a possibility that a gap is generated between the contact portion 32e and the contacted portion 31e due to a shape error of a part becomes low, so that there is an advantage that leakage of the air from the air chamber 17 is less likely to occur.

Further, in the modified embodiment shown in parts (a) and (b) of FIG. 14, a constitution in which the projected portion 27p of the discharge pipe 27 is press-fitted into the hole 31g may be employed. By this, it is possible to further suppress the leakage of the air from the air chamber 17 through the gap between the contact portion 32e and the contacted portion 31e without using the urging member.

Incidentally, in the embodiment or the modified embodiments shown in part (a) of FIG. 12 to part (b) of FIG. 14, in order to enhance adhesiveness between the contact portion 32e and the contacted portion 31e, a sealing member may also be disposed on either one or both of the contact portion 32e and the contacted portion 31e. The sealing member can use a material, such as a rubber or a sponge, which has elasticity and which does not have air permeability at least in a compressed state, for example.

### Transition of Toner Discharge State

Next, transition of a discharge state of the toner T in the toner accommodating chamber 16 will be described. Parts (a) to (c) of FIG. 15 are illustrations showing the discharge state of the toner T in the toner accommodating chamber 16. Part (a) of FIG. 15 shows an initial state before the toner T accommodated in the toner accommodating chamber 16 is discharged. Part (b) of FIG. 15 shows a state when a part of the toner T accommodated in the toner accommodating chamber 16 is discharged in the initial state. Part (c) of FIG. 15 shows a state when the toner T in the toner accommodating chamber 16 is further discharged from the state of part (b) of FIG. 15.

When the air is supplied to the air chamber 17 in the state shown in part (a) of FIG. 15, the air flows from the air chamber 17 into the toner accommodating chamber 16. Then, the toner T in the neighborhood of the inlet port 27a of the discharge pipe 27 flows together with the air into the discharge pipe 27, and is discharged to the outside of the toner cartridge C from the discharge port 27b.

As shown in part (b) of FIG. 15, when a gap is generated by discharge of the toner T in the neighborhood of the inlet port 27a, the toner T around the gap is pushed out toward the inlet port 27a by pressure for mutually pressing the toner (particles) in the toner accommodating chamber 16. For this reason, a region in the neighborhood of the inlet port 27a is filled with the toner T again. Further, when the toner T in the toner accommodating chamber 16 is decreased by the discharge of the toner T, a toner surface Ts of the toner T around the inlet port 27a lowers. When inclination of the toner surface Ts becomes severe, the toner surface Ts is collapsed toward a direction in which the toner surface Ts approaches the inlet port 27a, so that the toner T is moved.

As shown in part (c) of FIG. 15, when the remaining amount of the toner T is further decreased, the pressure for mutually pressing the toner (particles) becomes small. Here, in this embodiment, at the bottom of the toner accommodating chamber 16, an inclined portion 18c of the filter 18 is provided. The inclined portion 18c is formed so that the lowermost portion 18b overlaps with the inlet port 27a when viewed in the Y direction (vertical direction). The inclined portion 18c is inclined so as to become lower as the inclined portion 18c approaches the lowermost portion 18b of the filter 18. In other words, the inclined portion 18c is inclined with respect to the horizontal plane so as to move toward the vertical direction (−Y side) as the inclined portion 18c approaches the inlet port 27a in a direction in the horizontal plane (in the X-Z plane) perpendicular to the vertical direction.

For this reason, even in a state in which the remaining amount of the toner T becomes small, the toner T fluidized by the air flowed into the toner accommodating chamber 16 through the filter 18 is moved toward the lowermost portion 18b along inclination of the inclined portion 18c. Accordingly, even when the toner remaining amount in the toner accommodating chamber 16 becomes small, the toner T can be discharged more stably from the toner cartridge C.

Further, when the toner remaining amount becomes small, the toner amount of the toner T remaining in the toner accommodating chamber 16 without being discharged from the toner cartridge C can be made smaller.

Incidentally, an inclination angle of the inclined portion 18c, a flow rate of the air supplied by the pump 35, and the like have the influence on a discharging property (discharging capacity) of the toner T in the toner cartridge C. In order to discharge the toner T in a whole area of the toner accommodating chamber 16, it is effective that the angle of the inclined portion 18c is made large. On the other hand, when the angle of the inclined portion 18c is made excessively large, a volume of the toner accommodating chamber 16 becomes small. In addition thereto, each in view of flowability of the toner T and the like, it is desirable that the angle of the inclined portion 18c is set. For example, in a range in which the toner amount of the toner T remaining in the toner accommodating chamber 16 without being discharged from the toner cartridge C is sufficiently small, the angle of the inclined portion 18c is made as small as possible, so that the volume of the toner accommodating chamber 16 is made large. By this, the toner amount of the toner filled in the toner accommodating chamber 16 can be made large. The angle of the inclined portion 18c may be less than an angle of repose of the toner T.

### Advantage of Inlet Port Supporting Portion

An advantage of the inlet port supporting portion 32b provided to the toner cartridge C will be described. As described above, the inlet port 27a of the discharge port 27b is disposed so as to oppose the lowermost portion 18b of the filter 18 in the vertical direction (Y direction) (part (a) of FIG. 5). Further, as described above, the toner T in the toner accommodating chamber 16 is moved toward the lowermost portion 18b of the filter 18, so that even in a state in which the toner remaining amount of the toner T in the toner accommodating chamber 16 becomes small, it becomes possible to discharge the toner T.

If a position of the inlet port 27a is deviated from the lowermost portion 18b of the filter 18, there is a possibility that the discharging property of the toner T lowers. As a cause of a positional deviation of the inlet port 27a, for example, a shape error or assembling error of parts during manufacturing of the discharge port 27b, or a positional deviation of the discharge pipe 27 with vibration during image formation after the toner cartridge C is mounted to the apparatus main assembly A. When the position of the inlet port 27a is deviated from the lowermost portion 18b of the filter 18, there is a possibility that the toner T is not discharged irrespective of that the toner T remains in the neighborhood of the lowermost portion 18b of the filter 18 in a state in which the toner remaining amount of the toner T becomes small as shown in part (c) of FIG. 15.

In this embodiment, a constitution in which the neighborhood of the discharge port 27b of the discharge pipe 27 is supported by the inlet port supporting portion 32b is employed. By this, the positional deviation of the discharge port 27b with respect to the lowermost portion 18b of the filter 18 can be reduced. Accordingly, even when the toner remaining amount of the toner T in the toner accommodating chamber 16 becomes small, the toner T can be discharged more stably from the toner cartridge C. Further, when the toner remaining amount of the toner T becomes small, the toner amount of the toner T remaining in the toner accommodating chamber 16 without being discharged from the toner cartridge C can be made smaller.

It is preferable that a shortest distance from a connecting portion between the inlet port supporting portion 32b and the cartridge frame 32 to the inlet port 27a of the discharge pipe 27 is shorter than a shortest distance from the discharge port 27b to the inlet port 27a of the discharge pipe 27. By this, the positional deviation of the discharge port 27b can be restricted more certainly. The inlet port supporting portion 32b may be a member higher in rigidity than the discharge pipe 27.

Further, the inlet port supporting portion 32b may be a member extending in the substantially vertical direction (substantially Y direction) in a position immediately above the lowermost portion 18b of the filter 18 and the inlet port 27a of the discharge pipe 27. By this, the first portion 271 (part (a) of FIG. 5) in the neighborhood of the inlet port 27a of the discharge pipe 27 and the upper surface 322 (part (a) of FIG. 5) of the cartridge frame 32 are connected in a shortest distance, so that the positional deviation of the inlet port 27a can be restricted more certainly.

Incidentally, as in the modified embodiments described using FIG. 10 and FIG. 11, also in a constitution in which the inlet port supporting portion 32b has a function of the discharge pipe 27, the cartridge frame 32 and the neighborhood of the inlet port 27a of the discharge pipe 27 are connected by a structure other than a peripheral wall of the discharge pipe 27. Even in such a structure, it is possible to restrict the positional deviation of the inlet port 27a.

### Summary of Embodiment 1

According to the embodiment 1, the toner cartridge C is mounted to the mounting portion 31 of the apparatus main assembly A, so that the air chamber 17 which is the air chamber 17 enclosed by the toner cartridge C and the mounting portion 31 and to which the filter 18 is exposed is formed. Further, the toner cartridge C becomes a state in which the toner is dischargeable by supply of the air from the pump 35. In other words, in this embodiment, the cartridge is mounted to the mounting portion of the apparatus main assembly, so that the space (air chamber 17) which is the space enclosed by the cartridge and the mounting portion and to which the filter member of the cartridge is exposed is formed. Further, the above-described space is formed, so that the cartridge becomes a state (suppliable state) in which in the case where the air from the supplying means is supplied to the above-described space, the toner accommodated in the above-described accommodating space is dischargeable, from the above-described discharge port, together with the air passing through the filter member and flowing into the accommodating space.

According to this constitution, the air chamber 17 is formed by the toner cartridge C and the mounting portion 31 by mounting the toner cartridge C to the mounting portion 31, and the air from the pump 35 is supplied to the air chamber 17, so that toner supply of the toner from the toner cartridge C is realized. For this reason, there is no need to provide the air chamber 17 in the toner cartridge C. For example, in the case where the toner cartridge C is viewed in the vertically upward direction, there is no need that the bottom covering a whole of the filter 18 except for the hole for permitting connection of the air supply port 20 is provided as a part of the cartridge frame 32.

Thus, according to the embodiment 1 and the modified embodiments, it is possible to provide new embodiments of the image forming apparatus and the cartridge each including the constitution in which the toner is discharged from the cartridge by using the air.

Further, according to this embodiment, there is no need to provide, for example, the above-described bottom as a part of the cartridge frame 32, and therefore, it is possible to decrease a use amount of a material, such as a synthetic resin, used for molding the cartridge frame 32. For this reason, an environmental load during manufacturing of the toner cartridge C can be reduced. Further, it is possible to realize downsizing and weight reduction of the toner cartridge C.

Further, when compared with the case where, for example, the above-described bottom is a separate part from the cartridge frame 32, it is possible to reduce the number of parts of the toner cartridge C.

According to this embodiment, the cartridge is a cartridge such that an accommodating portion for accommodating the toner is provided inside the cartridge, and includes the filter member which forms the inner wall of the accommodating space and which has the air permeability and includes the discharge port for permitting discharge of the toner to the outside of the cartridge. Further, in an orientation of the cartridge in which the filter member becomes the bottom of the accommodating space, in the case where the cartridge is viewed in the vertically upward direction, a whole of the region, of the filter member, overlapping with the accommodating space is exposed. Here, the “orientation of the cartridge in which the filter member becomes the bottom of the accommodating space” is, for example, for example, an orientation when the toner cartridge C is mounted to the mounting portion 31.

According to this constitution, for example, by mounting the cartridge to the image forming apparatus main assembly provided with an appropriate constitution such as the mounting portion 31 described in this embodiment, it is possible to provide the cartridge capable of appropriately discharging the toner.

That is, according to the embodiment 1, it is possible to provide a new form of the cartridge provided with the constitution for discharging the toner from the cartridge by using the air.

### Embodiment 2

A toner cartridge C according to an embodiment 2 will be described. The toner cartridge C of this embodiment is mounted to the apparatus main assembly A of the image forming apparatus IF described in the embodiment 1 similarly as the toner cartridge C of the embodiment 1. In the following, elements to which reference symbols common to those of the embodiment 1 basically have the same constitutions and actions as those described in the embodiment 1 in the case where the elements are not particularly described, and a portion different from the embodiment 1 will be principally described.

### Pressure-Releasing Path

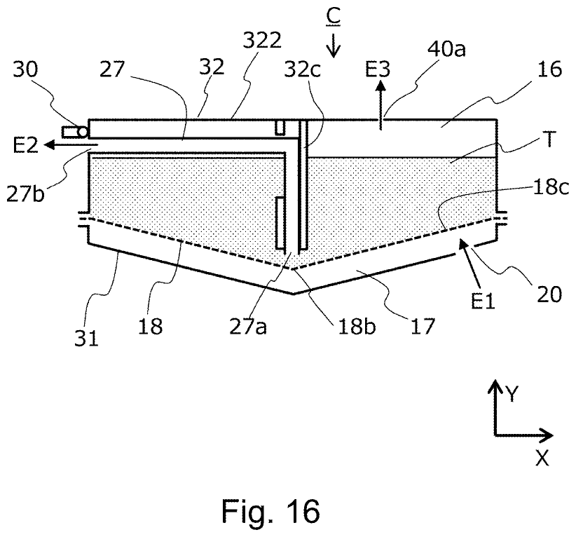

FIG. 16 is an illustration of the toner cartridge C according to the embodiment 2. FIG. 16 shows the toner cartridge C in a state in which the toner cartridge C is mounted to a mounting portion 31 of the apparatus main assembly A. The toner cartridge C of this embodiment includes a pressure releasing paths as a third opening (communicating portion) other than the discharge pipe 27 communicating the space (toner accommodating chamber 16) inside the toner cartridge C and the outside of the toner cartridge C with each other. The pressure releasing path of this embodiment is a hole 40a formed in the upper surface 322 of the cartridge frame 32.

The hole 40a is an outlet from which the air in the toner accommodating chamber 16 is escaped (released) to the outside of the toner cartridge C. By providing the hole 40a, in the case where the internal pressure of the toner accommodating chamber 16 is increased, it is possible to avoid leakage of the toner T and the air from an unintended portion (place) to the outside of the toner cartridge C. For example, the case where the toner cartridge C before being mounted to the apparatus main assembly A is gripped with a strong force more than expected and the internal pressure of the toner accommodating chamber 16 is increased will be considered. In this case, the inlet port 27a of the discharge pipe 27 and the filter 18 are covered with the toner T, so that movement of the air through the discharge pipe 27 or the filter 18 is prevented. On the other hand, the air comes out of the hole 40a, which is not covered with the toner T, to the outside of the toner cartridge C, so that it is possible to prevent that the internal pressure of the toner accommodating chamber 16 becomes excessively high.

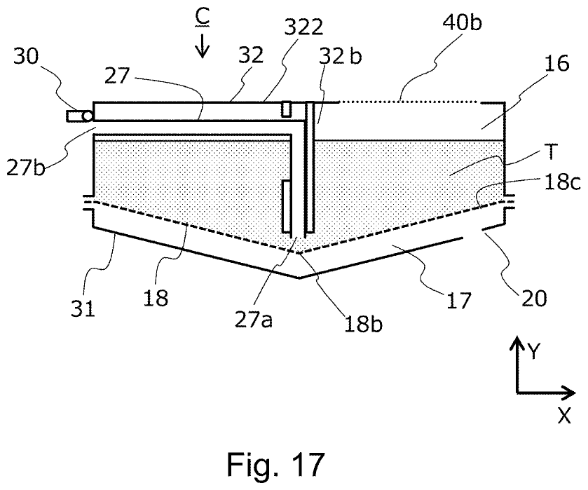

FIG. 17 is an illustration of a toner cartridge C according to a modified embodiment. FIG. 17 shows the toner cartridge C in a state in which the toner cartridge C is mounted to the mounting portion 31 of the apparatus main assembly A. The pressure releasing path in this embodiment is a filter portion 40b formed at the upper surface 322 of the cartridge frame 32. The filter portion 40b includes a hole formed in the cartridge frame 32 and a filter applied to the cartridge frame 32 so as to cover this hole. The filter is formed of a sheet material having air permeability such that passage of the air is permitted and passage of the toner T is prevented.

Even in the case where the filter portion 40b in the modified embodiment is used, in the case where the internal pressure of the toner accommodating chamber 16 is increased, it is possible to avoid leakage of the toner T and the air from an unintended portion to the outside of the toner cartridge C.

Incidentally, as a communicating portion (third opening, pressure releasing path), both the hole-shaped portion (FIG. 16) shown in the embodiment 2 and the filter (FIG. 17) shown in the modified embodiment may be provided. Further, a single toner cartridge C may also be provided with a plurality of pressure releasing paths.

### Air Permeation Amount of Pressure Releasing Path

The air permeation amount of the pressure releasing path (hole 40a) and a verification method thereof will be described using FIG. 16. An amount of the air (arrow E2) discharged from the discharge port 27b when the air (arrow E1) is taken into the air chamber 17 through the air supply port 20 is an air permeation amount G2, and an amount of the air (arrow E3) discharged from the pressure releasing path is an air permeation amount G3. The pressure releasing path (hole 40a) is provided so that the air permeation amount G2 becomes larger than the air permeation amount G3. Also, in the modified embodiment, the pressure releasing path (filter portion 40b) is provided so that an air permeation amount G2 of the discharge port 27b becomes larger than an air permeation amount G3 of the pressure releasing path (filter portion 40b).

The verification method of a relationship between the air permeation amounts G2 and G3 as described above may only be required to measure a volume (air permeation amount G2) of the air discharged from the discharge port 27b in a certain time and a volume (air permeation amount G3) of the air discharged from the pressure releasing path.

### Advantage of Pressure Releasing Path

An advantage of the pressure releasing path (communicating portion) will be described using FIG. 16. As described above, when the toner cartridge C is mounted to the mounting portion 31, the air chamber 17 enclosed by the toner cartridge C and the mounting portion 31 is formed. When the toner is supplied, the air is supplied from the pump 35 (FIG. 1) to the air chamber 17 and the internal pressure of the air chamber 17 is increased, so that when the air flows into the toner accommodating chamber 16 through the filter 18, the internal pressure of the toner accommodating chamber 16 is increased.

Here, the air permeation amount G2 of the discharge port 27b is larger than the air permeation amount G3 of the pressure releasing path (hole 40a). For this reason, the air in the toner accommodating chamber 16 increased in internal pressure principally passes through the discharge pipe 27 and is liable to go to the outside of the toner cartridge C. Accordingly, similarly as in the embodiment 1, the air in the toner accommodating chamber 16 passes together with the fluidized toner T through the discharge pipe 27 and is discharged from the discharge port 27b, so that the toner supply from the toner cartridge C to the process cartridge B becomes possible.

Even in the case where there are a plurality of pressure releasing paths and in the case where the filter portion 40b (FIG. 17) is included, if the air permeation amount G2 of the discharge port 27b is larger than the air permeation amount G3 of the pressure releasing path, the toner cartridge C is capable of discharging the toner T from the discharge port 27b in a similar manner.

Thus, even in the case where the toner cartridge C includes a path other than the discharge pipe 27 (discharge port 27b) communicating the toner accommodating chamber 16 and the outside of the toner cartridge C with each other, stable discharge of the toner T is enabled by constituting the toner cartridge C so that the air permeation amount satisfies a predetermined condition.

According to the embodiment 2 and the modified embodiment thereof described above, it is possible to provide new forms of the image forming apparatus and the cartridge each provided with the constitution in which the toner is discharged from the cartridge by using the air.

### Embodiment 3

A toner cartridge C according to an embodiment 3 will be described. The toner cartridge C of this embodiment is mounted to the apparatus main assembly A of the image forming apparatus IF described in the embodiment 1 similarly as the toner cartridge C of the embodiment 1. In the following, elements to which reference symbols common to those of the embodiment 1 basically have the same constitutions and actions as those described in the embodiment 1 in the case where the elements are not particularly described, and a portion different from the embodiment 1 will be principally described.

### Extension Portion

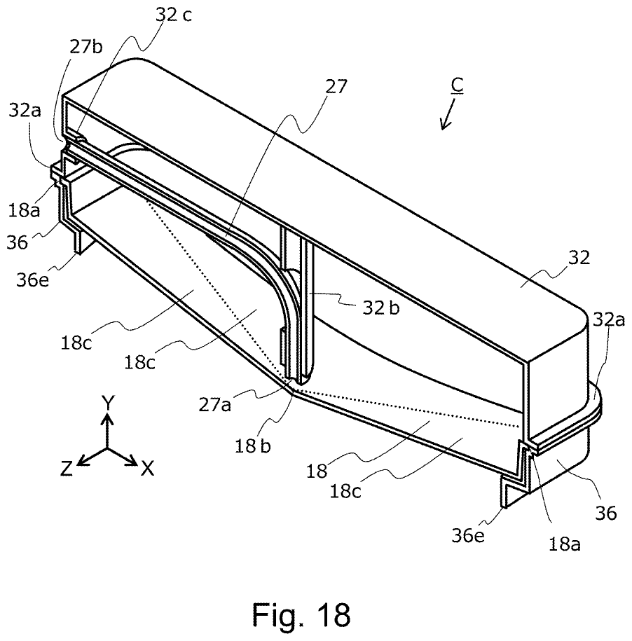

In this embodiment, orientation holding of the toner cartridge C will be described. FIG. 18 is a cross-sectional perspective view showing the toner cartridge C of this embodiment. The toner cartridge C includes an extension portion 36. The extension portion 36 extends downward (−Y side) than a lower end of the cartridge frame 32. The extension portion 36 projects downward (−Y side) than the lowermost portion 18b of the filter 18. The extension portion 36 forms the frame of the toner cartridge C in combination with the cartridge frame 32. In other words, the frame (32, 36) of the toner cartridge C includes the extension portion 36 as a container side wall which is a container side wall provided around the filter 18 as viewed in the gravitational direction and which extends toward the bottom wall portion 31b of the mounting portion 31.

An upper end portion of the extension portion 36 is bonded to a lower end portion (flange portion 32a) of the cartridge frame 32. A bonding method is not particularly limited, and for example, it is possible to select either one of the ultrasonic welding, the thermal welding, the bonding with the adhesive such as the hot-melt adhesive, and the mechanical bonding with the screws.

As viewed in the Y direction, the extension portion 36 is a hollow (annular, cylindrical) member with hole at a central portion thereof. A whole circumference of the upper end portion of the extension portion 36 and a whole circumference of the flange portion 32a are bonded to each other. When the toner cartridge C before mounted to the apparatus main assembly A is viewed in the Y direction, most of the filter 18 is exposed to an inside of the extension portion 36.

At a lower end of the extension portion 36, a contact portion 36e contacting a contacted portion 31e (parts (a) and (b) of FIG. 20) of the mounting portion 31 in the case where the toner cartridge C is mounted to the mounting portion 31 is provided. The contact portion 36e is an end surface of the extension portion 36 in the mounting direction (arrow D of part (a) of FIG. 20) of the toner cartridge C. Contact between the contact portion 36e and the contacted portion 31e will be described later. In this embodiment, over a whole circumference of the extension portion 36 a height of the contact portion 36e in the Y direction is uniform.

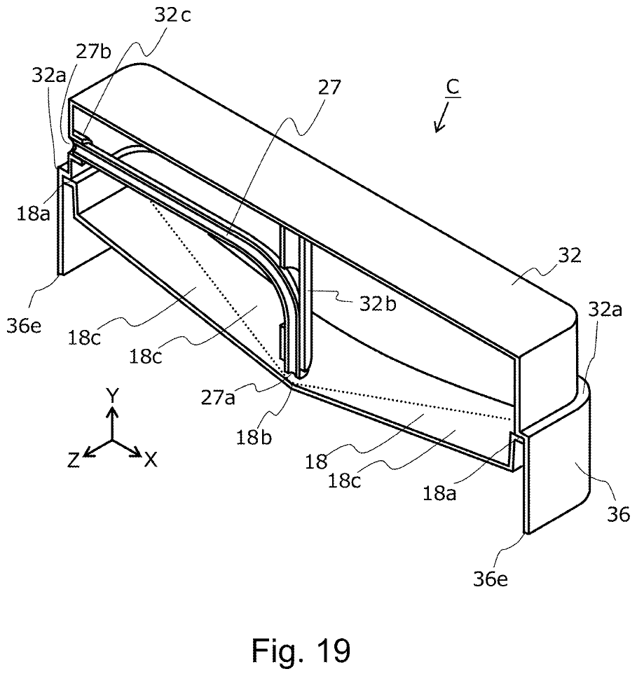

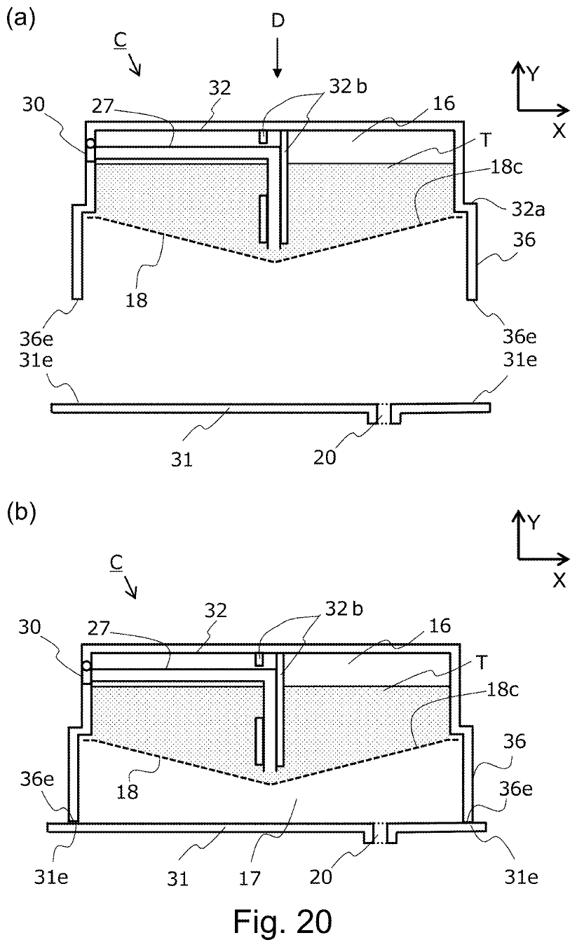

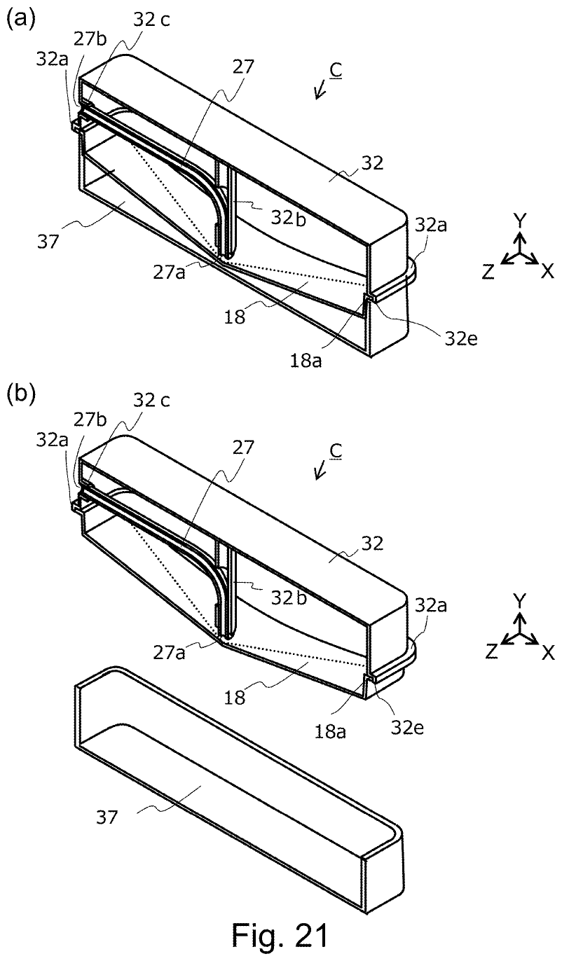

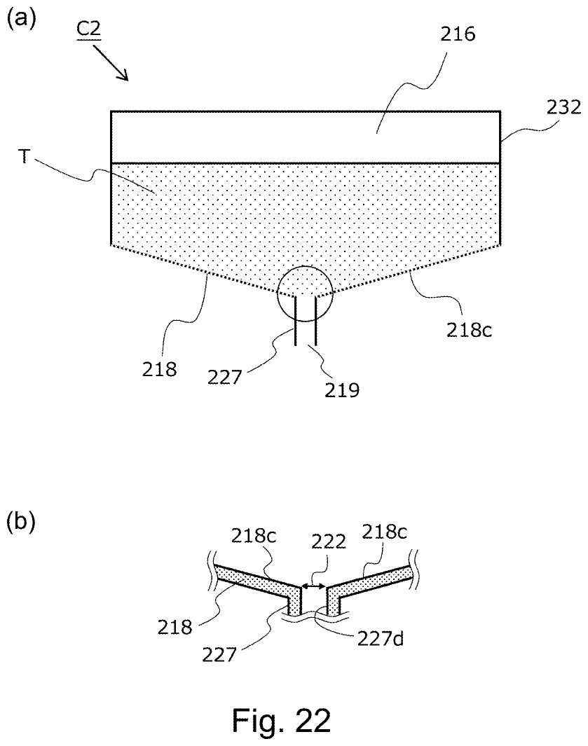

FIG. 19 is a cross-sectional perspective view showing a toner cartridge C according to a modified embodiment. The toner cartridge C of this modified embodiment includes an extension portion 36 as a part of the cartridge frame 32. The extension portion 36 extends downward (−Y side) from the flange portion 32a of the cartridge frame 32.

The extension portion 36 projects downward (−Y side) than the lowermost portion 18b of the filter 18. The extension portion 36 of this modified embodiment is another example of a container side wall which is a container side wall provided around the filter 18 as viewed in the gravitational direction and which extends toward the bottom wall portion 31b of the mounting portion 31.

As viewed in the Y direction, the extension portion 36 is formed in a hollow shape (annular shape, cylindrical shape) with a hole at a central portion thereof. When the toner cartridge C before mounted to the apparatus main assembly A is viewed in the Y direction, most of the filter 18 (most of the bottom of the toner accommodating chamber 16) is exposed to the inside of the extension portion 36.

At a lower end of the extension portion 36, a contact portion 36e contacting the contacted portion 31e (parts (a) and (b) of FIG. 20) of the mounting portion 31 in the case where the toner cartridge C is mounted to the mounting portion 31 is provided. Contact between the contact portion 36e and the contacted portion 31e will be described later. In this embodiment, over a whole circumference of the extension portion 36, a height of the contact portion 36e in the Y direction is uniform.

Part (a) of FIG. 20 is an illustration showing a state before the toner cartridge C according to a modified embodiment is mounted to the mounting portion 31. Part (b) of FIG. 20 is an illustration showing a state in which the toner cartridge C according to the modified embodiment is mounted to the mounting portion 31.

When the toner cartridge C according to the modified embodiment is mounted to the mounting portion, the contact portion 36e of the lower end of the extension portion 36 contacts the contacted portion 31e of the mounting portion 31. By this, the air chamber 17 which is a space enclosed by the toner cartridge C and the mounting portion 31 is formed. That is, in this modified embodiment, the air chamber 17 (second chamber) is enclosed by the filter 18, the bottom wall portion 31b, and the extension portion 36 (container side wall). Similarly, also in the case of the toner cartridge C according to the embodiment 3, the contact portion 36e of the lower end of the extension portion 36 contacts the contacted portion 31e of the mounting portion 31, whereby the air chamber 17 which is the space enclosed by the toner cartridge C and the mounting portion 31 is formed. At least one of the contact portion 36e and the contacted portion 31e may also be provided with a sealing member for improving adhesiveness between the contact portion 36e and the contacted portion 31e.

### Advantage of Extension Portion

In this embodiment and the modified embodiment, the extension portion 36 projects downward than the lowermost portion of the filter 18. For this reason, when the toner cartridge C is placed on a desk or the like, the filter 18 does not contact the desk, so that a possibility that an orientation of the toner cartridge C becomes unstable can be reduced. Further, a possibility that dirt is deposited on the filter 18 and air permeability lowers can be reduced.

Further, in this embodiment and the modified embodiment, the contact portion 36e is provided at the lower end of the extension portion 36 projecting downward (−Y side) than the lowermost portion 18b of the filter 18. For this reason, as shown in parts (a) and (b) of FIG. 20, for example, even in the case where a flat plate-shaped mounting portion 31 is used, the air chamber 17 can be appropriately formed, so that mounting of the toner cartridge C can be made easy. In other words, by providing the extension portion 36, a position where the toner cartridge C and the mounting portion 31 contact each other for forming the air chamber 17 can be set to a position separated from a bonding portion between the cartridge frame 32 and the filter 18.

According to the embodiment 3 and the modified embodiment thereof described above, it is possible to provide new forms of the image forming apparatus and the cartridge each provided with the constitution in which the toner is discharged from the cartridge by using the air.

### Embodiment 4

A toner cartridge C according to an embodiment 4 will be described. The toner cartridge C of this embodiment is mounted to the apparatus main assembly A of the image forming apparatus IF described in the embodiment 1 similarly as the toner cartridge C of the embodiment 1. In the following, elements to which reference symbols common to those of the embodiment 1 basically have the same constitutions and actions as those described in the embodiment 1 in the case where the elements are not particularly described, and a portion different from the embodiment 1 will be principally described.

### Protective Member

Part (a) of FIG. 21 is a cross-sectional perspective view of a toner cartridge C according to an embodiment 4. Part (b) of FIG. 21 is a cross-sectional perspective view showing the toner cartridge C in a state in which a protective member 37 is removed.

As shown in part (a) of FIG. 21, the toner cartridge C of this embodiment is provided with the protective member 37 (cover member) for protecting the filter 18. The protective member 37 is mounted to the cartridge frame 32 so as to cover at least a part (preferably a whole) of the filter 18 when the toner cartridge C is viewed in the Y direction.

The toner cartridge C includes a contact portion 32e. A constitution of the contact portion 32e may be the same as, for example, that described in the embodiment 1 (parts (a) and (b) of FIG. 12).

The protective member 37 is removable (detachable) from the cartridge frame 32 or movable relative to the cartridge frame 32 so as to expose the filter 18. In the case where the toner cartridge C is mounted to the mounting portion 31, the protective member 37 is removed in advance (part (b) of FIG. 21). A user moves the toner cartridge C in the mounting direction (arrow D) to the mounting portion 31 in the state in which the protective member 37 is removed. By this, the contact portion 32e contacts the contacted portion 31e of the mounting portion 31, so that the air chamber 17 is formed (part (b) of FIG. 12). That is, by removing the protective member 37, the toner cartridge C becomes a state in which the toner cartridge C is appropriately mountable to the mounting portion 31.

### Advantage of Protective Member

In the case where the filter 18 is formed of a low-rigidity material such as a nonwoven fabric, when the filter 18 receives a strong force in the case where the filter 18 is supposed to contact a sharp object or in the like case, it would be considered that the filter 18 is broken and the toner is leaked out. In this embodiment, the filter 18 is protected by the protective member 37, so that a possibility that the filter 18 is broken can be reduced.

Incidentally, the material of the filter 18 is not limited to the nonwoven fabric, but is capable of being made to have high rigidity by a means such as heat press molding or sintering, for example. By enhancing strength of the filter 18 itself, a possibility that the filter 18 is broken can be reduced. Even in this case, by providing the protective member 37 of this embodiment, it is possible to reduce the possibility that air permeability is lowered due to deposition of dirt on the filter 18, for example, when the toner cartridge C is placed on a desk or the like.

According to the embodiment 4 and the modified embodiment thereof described above, it is possible to provide new forms of the image forming apparatus and the cartridge each provided with the constitution in which the toner is discharged from the cartridge by using the air.

### Embodiment 5

A toner cartridge C2 and an image forming apparatus IF which are according to an embodiment 5 will be described. In the following, elements to which reference symbols common to those of the embodiment 1 basically have the same constitutions and actions as those described in the embodiment 1 in the case where the elements are not particularly described, and a portion different from the embodiment 1 will be principally described.

### Toner Cartridge

By using parts (a) and (b) of FIG. 22, the toner cartridge C2 according to the embodiment 5 will be described. Part (a) of FIG. 22 is a sectional view of the toner cartridge C2. Part (b) of FIG. 22 is an enlarged view of a region shown by a circle in part (a) of FIG. 22. In each of views of parts (a) and (b) of FIG. 22 and later, it is assumed that the toner cartridge C2 is in an orientation when mounted to the apparatus main assembly A.

First, an overall constitution of the toner cartridge C2 will be described. As shown in parts (a) and (b) of FIG. 22, the toner cartridge C2 includes a cartridge frame 232 and a filter 218 (filter member). The filter 218 is a sheet-like member (filter member, ventilation member) having air permeability. By the cartridge frame 232 and the filter 218, a toner accommodating chamber 216 which is an accommodating space (toner accommodating portion) for accommodating the toner T is formed. The toner accommodating chamber 216 is an inside space of the toner cartridge C2. The filter 218 forms at least a part of a bottom of the toner accommodating chamber 216.

A discharge pipe 227 is provided at a lower end portion of the toner cartridge C2. The discharge pipe 227 forms a flow path which is a space for communicating the toner accommodating chamber 216 and an outside space of the toner cartridge C2 with each other. A lower end of the discharge pipe 227 is a discharge port 219 through which the toner T is discharged to an outside of the toner cartridge C2. In this embodiment, the discharge pipe 227 is connected to the filter 218.

The filter 218 forms the bottom of the toner accommodating chamber 216. The filter 218 includes an inclined portion 218c inclined toward a lowermost portion 218b. That is, at least a part of the bottom of the toner accommodating chamber 216 is an inclined surface inclined with respect to the horizontal plane.

The lowermost portion 218b of the filter 218 is an opening 222 (inlet port of the discharge pipe 227) continuous to the discharge pipe 227. That is, in this embodiment, the bottom of the toner accommodating chamber 216 is provided with a hole communicating with the discharge pipe 227, and at least a part of the bottom is inclined with respect to the horizontal plane so as to be directed downward (−Y side) as being closer to the hole.

The filter 218 is formed of a material which permits passage of the air and which prevents passage of the toner T. The filter 218 is formed of, for example, a sheet material which is a porous sheet material comprising resin fibers and which has a size and a density such that the passage of the air is permitted and the passage of the toner T is prevented. As the filter 218, for example, a nonwoven fabric can be used. Further, a filter material molded by heat-pressing, sintering, or the like may also be used.

The filter 218 and the discharge pipe 227 may also be formed integrally with each other by using a common material. Incidentally, the discharge pipe 227 is a tubular member having no air permeability.

### Mechanism of Toner Discharge

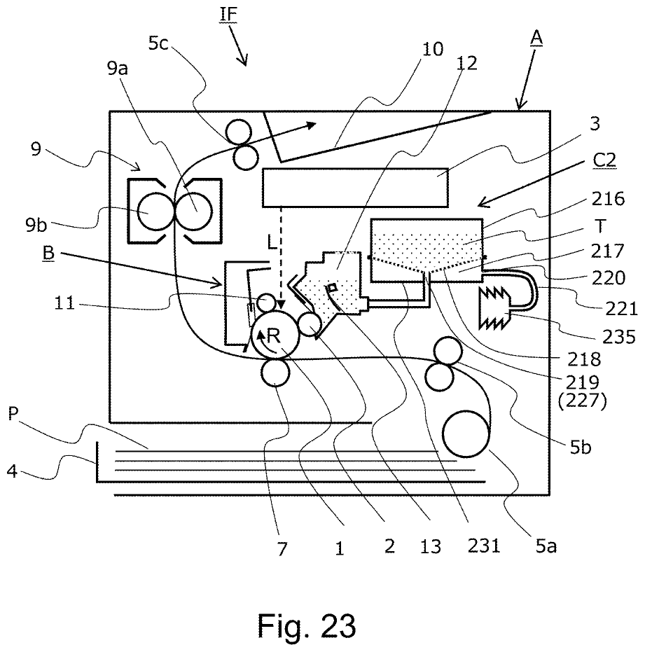

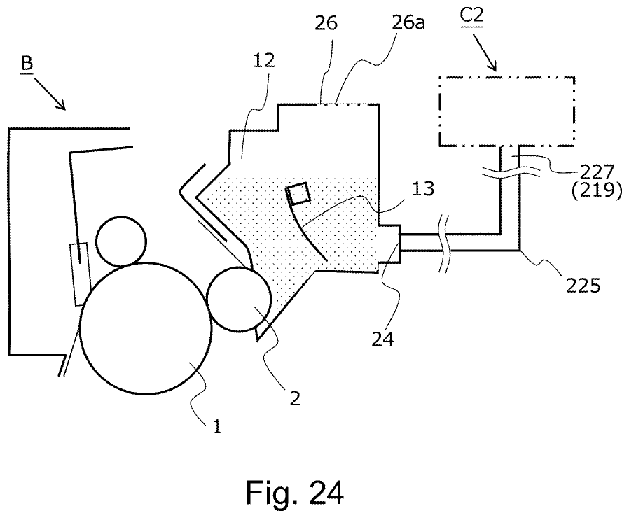

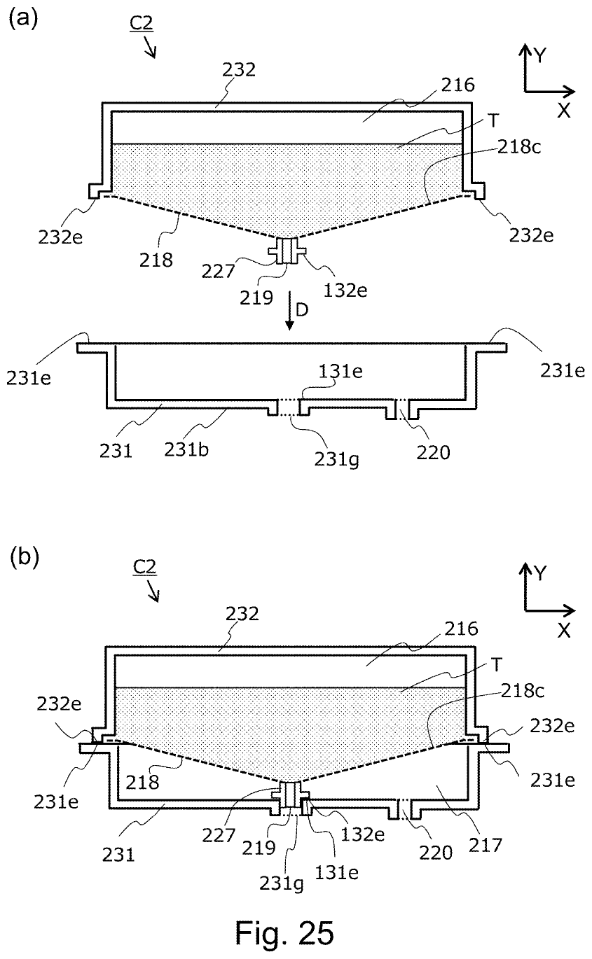

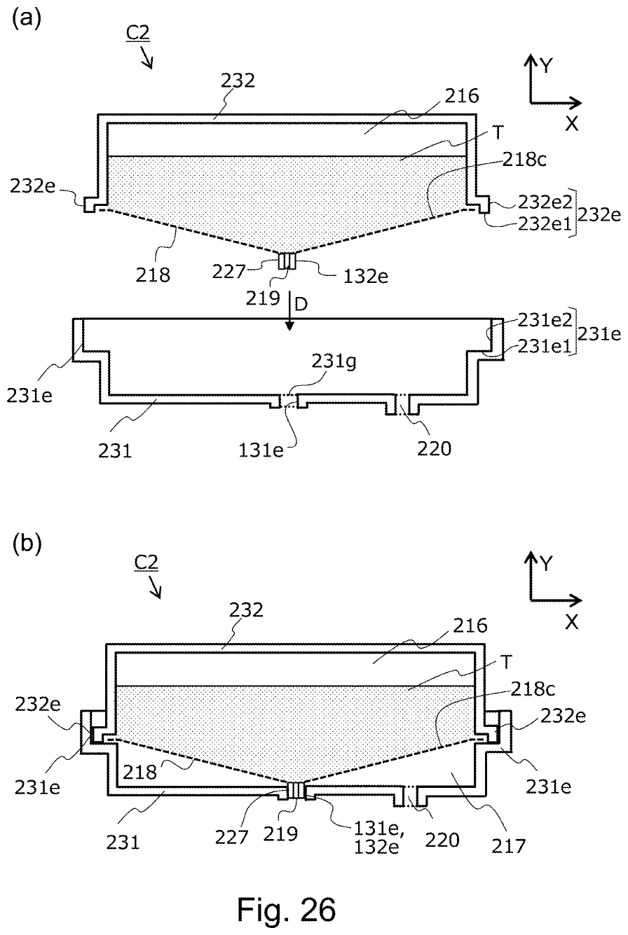

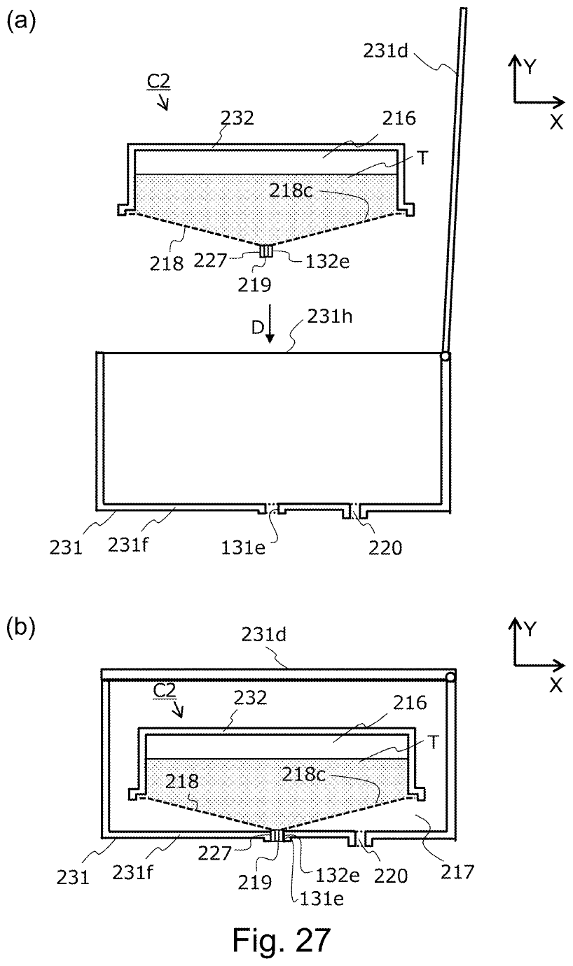

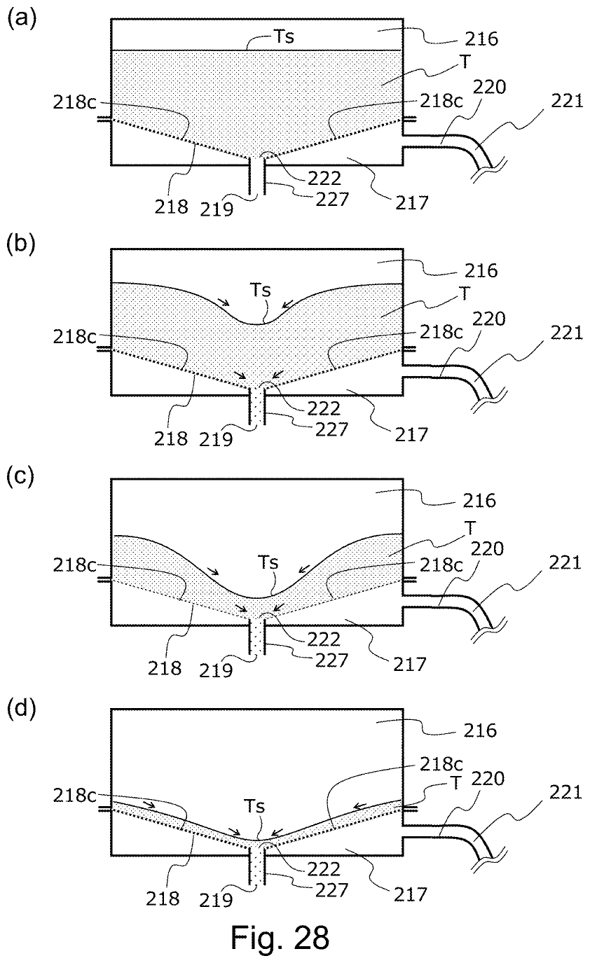

Next, a mechanism in which the toner is discharged from the toner cartridge C2 will be described using FIG. 23 and FIG. 24. FIG. 23 is a sectional view of the image forming apparatus IF in which the toner cartridge C2 according to this embodiment is mounted. FIG. 24 is a schematic view showing the toner cartridge C2 and a process cartridge B which are mounted to the apparatus main assembly A.

As shown in FIG. 23, the apparatus main assembly A includes a pump 235 (air pump) as an air supplying portion or a supply means for supplying the air to the air chamber 217 described later. Further, the apparatus main assembly A includes an air supply port 220 supplied with the air from the pump 235, and an air supply pipe 221 connecting the pump 235 and the air supply port 220. The pump 235 (air pump) may also be, for example, either one of a reciprocating pump, a diagram pump, or a rotary pump. Incidentally, for example, a fan may also be used as the supplying means.

Further, the apparatus main assembly A includes the mounting portion 31 (cartridge installation portion, cartridge interface portion) to which the toner cartridge C2 is mounted. In a state in which the toner cartridge C2 is mounted to the apparatus main assembly A, the air chamber 217 which is a space enclosed by the toner cartridge C2 and the mounting portion 231. The air supply port 220 is provided to the mounting portion 231 and opens to the air chamber 217.

In the state in which the toner cartridge C2 is mounted to the apparatus main assembly A, the filter 218 is exposed to the air chamber 217. Specifically, of the filter 218, at least a whole of a region forming the bottom of the toner accommodating chamber 216 is exposed to the air chamber 217. In the state in which the toner cartridge C2 is mounted to the apparatus main assembly A, at least a part of a ceiling surface of the air chamber 217 is formed by the filter 218 of the toner cartridge C2.

The compressed air discharged by the pump 235 is supplied to the air chamber 217 through the air supply port 220. The air chamber 217 is a substantially closed space except for the air supply port 220 and pores of the filter 218, and therefore, air pressure (internal pressure) in the air chamber 217 increased by the air from the pump 235. When the air pressure in the air chamber 217 is increased, the air flows into the toner accommodating chamber 216 through the filter 218.

The air flowing in the toner accommodating chamber 216 fluidizes the toner T in the toner accommodating chamber 216. Then, the air mixed with the toner T flows into a flow path of the discharge pipe 227 and passes through a discharge port 219, and is discharged to the outside of the toner cartridge C2. Then, the air mixed with the toner T flows into the toner chamber 12 in the process cartridge B through the receiving port 24 of the process cartridge B connected to the discharge port 219.

In this embodiment, the discharge port 219 and the receiving port 24 are connected through a relay pipe 225 as a toner conveying means (relaying means). The relay pipe 225 may be provided to the apparatus main assembly. In this case, the receiving port 24 and one end of the relay pipe 225 are connected to each other by mounting of the process cartridge B, and the discharge port 219 and the other end of the relay pipe 225 are connected to each other by mounting of the toner cartridge C2. Incidentally, a constitution in which the discharge port 219 and the receiving port 24 are directly connected to each other may also be employed.

As shown in FIG. 24, to the process cartridge B, the discharge portion 26 communicating the toner chamber 12 in the process cartridge B and the outside of the process cartridge B with each other is provided, and internal pressure of the toner chamber 12 is equal to ambient (atmospheric) pressure in general. For this reason, when the internal pressures of the air chamber 217 and the toner accommodating chamber 216 are increased by the air supplied from the pump 235, the internal pressure of the toner accommodating chamber 216 becomes higher than the internal pressure of the toner chamber 12. For this reason, the air mixed with the toner T is moved from the toner accommodating chamber 216 to the toner chamber 12 through the discharge pipe 227 and the relay pipe 225.

When the air mixed with the toner T flows into the toner chamber 12, the internal pressure of the toner chamber 12 is temporarily increased. However, the discharge portion 26 is capable of discharging the air inside the toner chamber 12 to the outside of the process cartridge B, and therefore the internal pressure of the toner chamber 12 lowers. In this embodiment, after the internal pressure of the toner chamber 12 is temporarily increased, the internal pressure of the toner chamber 12 quickly lowers to a value substantially equal to the ambient pressure.

Incidentally, although an example in which the pump 235 in this embodiment, is provided in the apparatus main assembly A was described, but the pump 235 may also be mounted to the process cartridge B or the toner cartridge C2.

### Connecting Portion between Apparatus Main Assembly and Toner Cartridge

Next, a constitution of a connecting portion between the apparatus main

assembly A and the toner cartridge C2 will be described using parts (a) and (b) of FIG. 25.

Parts (a) and (b) of FIG. 25 are sectional views showing the mounting portion 231 provided in the apparatus main assembly A, and the toner cartridge C2. Part (a) of FIG. 25 shows a state before the toner cartridge C2 is mounted to the mounting portion 231. Part (b) of FIG. 25 shows a state in which the toner cartridge C2 is mounted to the mounting portion 231.

As shown in part (a) of FIG. 25, the toner cartridge C2 includes a first contact portion 132e and a second contact portion 232e. The mounting portion 231 includes a first contacted portion 131e, a second contacted portion 231e, the above-described air supply port 220, and a hole 231g.

In the case where the toner cartridge C2 is mounted to the mounting portion 231, the first contact portion 132e contacts the first contacted portion 131e, and the second contact portion 232e contacts the second contacted portion 231e. By contact between the first contact portion 132e and the first contacted portion 131e and by contact between the second contact portion 232e and the second contacted portion 231e, the air chamber 217 is formed as a space enclosed by the toner cartridge C2 and the mounting portion 231. Further, the discharge pipe 227 of the toner cartridge C2 is inserted into the hole 231g, so that the discharge port 219 is connected to the relay pipe 225 (FIG. 24). Then, the air from the pump 235 is supplied to the air chamber 217 through the air supply port 220, so that the toner supply from the toner cartridge C2 to the process cartridge B is performed as described above.

The first contact portion 132e, the second contact portion 232e, the first contacted portion 131e, and the second contacted portion 231e in this embodiment will be specifically described. As shown in part (a) of FIG. 25, in this embodiment, the toner cartridge C2 is mounted to the mounting portion 231 by being moved and operated from an upward side (+Y side) of the mounting portion 231 in a downward mounting direction (arrow D) in the vertical direction.

As specific constitution of the second contact portion 232e and the second contacted portion 231e may be the same as that of the contact portion 32e and the contacted portion 31e described in the embodiment 1.

The first contact portion 132e is provided to a flange portion projecting, from an outer periphery of the discharge pipe 227 extending along the mounting direction (arrow D), in a direction crossing the mounting direction (arrow D). The first contact portion 132e is an annular surface directed in the mounting direction (arrow D). The first contact portion 132e is provided over a whole circumference around the discharge pipe 227. Further, the first contact portion 132e in this embodiment has a flat surface shape perpendicular to the Y direction.

The first contacted portion 131e is provided at a bottom 231b of the mounting portion 231. Of the bottom 231b, the first contacted portion 131e is a peripheral portion of the hole 231g in which the discharge pipe 227 is engaged. The first contacted portion 131e in this embodiment has a flat surface shape perpendicular to the Y direction.

Parts (a) and (b) of FIG. 26 are sectional views of a toner cartridge C2 and a mounting portion 231 according to a modified embodiment. A second contact portion 232e includes a downstream-side end surface 232e1 of a cartridge frame 232 in the mounting direction (arrow D) of the toner cartridge C2 and includes an end surface 232e2 directed to the outside of the toner cartridge C2 in directions crossing the mounting direction (arrow D). Further, a second contacted portion 231e in this modified embodiment includes an upstream-side end surface 231e1 of the mounting portion 231 in the mounting direction (arrow D) of the toner cartridge C2 and includes an end surface 231e2 directed to an inside in the directions (X direction, Z direction) crossing the mounting direction (arrow D).

A specific constitution of the second contact portion 232e and the second contacted portion 231e may be the same as that described in the modified embodiment (parts (a) and (b) of FIG. 13) of the embodiment 1. According to this modified embodiment, compared with the embodiment 5, the air can be made less likely to leak out from the air chamber 217.

Further, in the modified embodiment of parts (a) and (b) of FIG. 26, the first contact portion 132e is an outer peripheral surface of the discharge pipe 227, and the first contacted portion 131e is an inner peripheral surface of the hole 231g.

Parts (a) and (b) of FIG. 27 are sectional views of a toner cartridge C2 and a mounting portion 231 according to another modified embodiment. The mounting portion 231 of this modified embodiment includes a cartridge accommodating portion 31f including an opening 231h on a side opposite to a mounting direction (arrow D) of the toner cartridge C2 and a lid portion 231d for opening and closing the opening 31h. The toner cartridge C2 is detachably mountable to the cartridge accommodating portion 231f through the opening 231h in a state (part (a) of FIG. 27) in which the lid portion 231d is opened.

In this modified embodiment, the toner cartridge C2 includes the first contact portion 132e, and the mounting portion 231 includes the first contacted portion 131c. The toner cartridge C2 and the mounting portion 231 in this modified embodiment do not include the second contact portion 232e and the second contacted portion 231e in the embodiment 5. In this modified embodiment, the first contact portion 132e is an outer peripheral surface of the discharge pipe 227, and the first contacted portion 131e is an inner peripheral surface of the hole 231g.

When the toner cartridge C2 is inserted into the cartridge accommodating portion 231f, the first contact portion 132e and the first contacted portion 131e contact each other. Then, when the lid portion 231d is closed, an air chamber 217 as a space enclosed by the toner cartridge C2 and the mounting portion 231 is formed. The air chamber 217 in this modified embodiment is formed by an inner in which the cartridge accommodating portion 231f, an inner wall of the lid portion 231d, a surface of the filter 218, and a surface of the cartridge frame 232.

### Advantage of Connecting Portion

In a constitution of this embodiment shown in parts (a) and (b) of FIG. 25, the first contact portion 132e and the second contact portion 232e are surfaces directed in the mounting direction (arrow D), and the first contacted portion 131e and the second contacted portion 231e are surfaces directed toward a side opposite to the mounting direction (arrow D). For this reason, by an operation for moving the toner cartridge C2 in the mounting direction (arrow D), the first contact portion 132e and the second contact portion 232e can be contacted to the first contacted portion 131e and the second contacted portion 231e, respectively.

Each of a contact region between the first contact portion 132e and the first contacted portion 131e and a contact region between the second contact portion 232e and the second contacted portion 231e is provided in an annular shape (circumferential shape, closed curve shape). For this reason, when the first contact portion 132e and the first contacted portion 131e contact each other and the second contact portion 232e and the second contacted portion 231e contact each other, the air chamber 217 which is the space enclosed by the toner cartridge C2 and the mounting portion 231 becomes a substantially closed space except for the air supply port 220 and the pores of the filter 218. For this reason, when the air is supplied from the air supply port 220 to the air chamber 217, internal pressure of the air chamber 217 increases. Then, the air flows from the air chamber 217 into the toner accommodating chamber 216 through the filter 218, so that the toner T discharged from the toner cartridge C2 by the above-described mechanism.

In other words, in the state in which the toner cartridge C2 is mounted to the mounting portion 231. A path of the air from the air chamber 217 to the discharge port 219 through the filter 218, the toner accommodating chamber 216, and the discharge pipe 227 is formed. In order to appropriately from the path of the air, it is desirable that the toner cartridge C2 and the mounting portion 231 contact each other in the annular contact region and that the filter 218 is present in a region which is a region, of the surface of the toner cartridge C2, on one side with respect to the annular contact region and which is exposed to the air chamber 217. Further, in order to appropriately from the path of the air, it is desirable that the discharge port 219 is present in a region of the surface of the toner cartridge C2, on the other side with respect to the annular contact region.

In the embodiment 5, a region in which the first contact portion 132e and the first contacted portion 131e contact each other corresponds to the above-described annular contact region. For this reason, the toner cartridge C2 and the mounting portion 231 can appropriately form the path of the air passing from the air chamber 217 through the filter 218, the toner accommodating chamber 216, the discharge pipe 227, and the discharge port 219.

In order to prevent the air from leaking out from a gap between the first contact portion 132e and the first contacted portion 131e, it is desirable that the first contact portion 132e and the second contacted portion 131e hermetically contact each other over a full circumference. For that reason, an urging member for urging the toner cartridge C2 to the mounting portion 231 in the mounting direction (arrow D) so as to press the first contact portion 132e to the first contacted portion 131e may also be provided. Further, an urging member for urging the mounting portion 231, to the toner cartridge C2, toward a side opposite to the mounting direction (arrow D) so as to press the first contacted portion 131e to the first contact portion 132e. The urging member may also be provided to either one of the toner cartridge C2 and the apparatus main assembly A. The urging member may be an elastic member, such as a spring or a rubber, provided to the toner cartridge C2 so as to contact the apparatus main assembly A during mounting of the toner cartridge C2 toward the apparatus main assembly A, for example. Further, the urging member may also be magnet.

Similarly, in order to prevent the air from leaking out from a gap between the second contact portion 232e and the second contacted portion 231e, it is desirable that the second contact portion 232e and the second contacted portion 231e hermetically contact each other over a whole circumference. For this reason, the above-described urging member for urging either one of the toner cartridge C2 and the mounting portion 231 toward the other one may also be provided.

Further, in the modified embodiment shown in parts (a) and (b) of FIG. 26, a constitution in which the discharge pipe 227 is press-fitted to the hole 231g and in which the end surface 232e2 on the outside of the cartridge frame 232 is press-fitted to the end surface 231e2 on the inside of the mounting portion 231 may be employed. By this, without using the urging member, the first contact portion 132e and the first contacted portion 131e can be hermetically contacted to each other, and the second contact portion 232e and the second contacted portion 231e can be hermetically contacted to each other. That is, without using the urging member, it is possible to suppress the leakage of the air from the air chamber 217 through the gap between the toner cartridge C2 and the mounting portion 231.

Further, in the modified embodiment shown in parts (a) and (b) of FIG. 27, compared with the embodiment 5 shown in parts (a) and (b) of FIG. 25 and the modified embodiments shown in parts (a) and (b) of FIG. 26, the second contact portion 232e and the second contacted portion 231e can be omitted. For this reason, the air chamber 217 can be formed while reducing a contact portion, between the toner cartridge C2 and the mounting portion 231, in which there is a possibility that the air is leaked out from a gap therebetween.

Incidentally, in the embodiment or the modified embodiments shown in part (a) of FIG. 25 to part (b) of FIG. 27, in order to enhance adhesiveness between the first contact portion 132e and the first contacted portion 131e, a sealing member may also be disposed on either one or both of the first contact portion 132e and the first contacted portion 131e. Further, in order to enhance adhesiveness between the second contact portion 232e and the second contacted portion 231e, the sealing member may be disposed on either one or both of the second contact portion 232e and the second contacted portion 231e. The sealing member can use a material, such as a rubber or a sponge, which has elasticity and which does not have air permeability at least in a compressed state, for example.

### Transition of Toner Discharge State

Next, transition of a discharge state of the toner T in the toner accommodating chamber 216 will be described. Parts (a) to (d) of FIG. 28 are illustrations showing the discharge state of the toner T in the toner accommodating chamber 216. Part (a) of FIG. 28 shows an initial state before the toner T accommodated in the toner accommodating chamber 216 is discharged. Part (b) of FIG. 28 shows a state when a part of the toner T accommodated in the toner accommodating chamber 216 is discharged in the initial state. Part (c) of FIG. 28 shows a state when the toner T in the toner accommodating chamber 216 is further discharged from the state of part (b) of FIG. 28. Part (d) of FIG. 28 shows a state when the toner T in the toner accommodating chamber 216 is further discharged from the state of part (c) of FIG. 28.

When the air is supplied to the air chamber 217 in the state shown in part (a) of FIG. 28, the air flows from the air chamber 217 into the toner accommodating chamber 216. Then, the toner T in the neighborhood of an opening 222 of the filter 218 flows together with the air into the discharge pipe 227, and is discharged to the outside of the toner cartridge C2 from the discharge port 219.

As shown in parts (b) and (c) of FIG. 28, when a gap is generated by discharge of the toner T in the neighborhood of the opening 222, the toner T around the gap is pushed out toward the opening 222 by pressure for mutually pressing the toner (particles) in the toner accommodating chamber 216. For this reason, a region in the neighborhood of the opening 222 is filled with the toner T again. Further, when the toner T in the toner accommodating chamber 216 is decreased by the discharge of the toner T, a toner surface Ts of the toner T lowers at a position above the opening 222. When inclination of the toner surface Ts becomes severe, the toner surface Ts is collapsed toward a direction in which the toner surface Ts approaches the opening 222, so that the toner T is moved.

As shown in part (d) of FIG. 28, when the remaining amount of the toner T is further decreased, the pressure for mutually pressing the toner (particles) becomes small. Here, in this embodiment, at the bottom of the toner accommodating chamber 216, an inclined portion 218c of the filter 218 is provided. The inclined portion 218c is inclined so as to become lower as the inclined portion 218c approaches the opening 222 which is the lowermost portion of the filter 218. In other words, the inclined portion 218c is inclined with respect to the horizontal plane so as to move downward (−Y side) as the inclined portion 218c approaches the opening 222 in a direction in the horizontal plane (in the X-Z plane) perpendicular to the vertical direction.

For this reason, even in a state in which the remaining amount of the toner T becomes small, the toner T fluidized by the air flowed into the toner accommodating chamber 216 through the filter 218 is moved toward the opening 222 along inclination of the inclined portion 218c. Accordingly, even when the toner remaining amount in the toner accommodating chamber 216 becomes small, the toner T can be discharged more stably from the toner cartridge C2. Further, when the toner remaining amount becomes small, the toner amount of the toner T remaining in the toner accommodating chamber 216 without being discharged from the toner cartridge C2 can be made smaller.

According to the embodiment 5 and the modified embodiment thereof described above, it is possible to provide new forms of the image forming apparatus and the cartridge each provided with the constitution in which the toner is discharged from the cartridge by using the air.

### Modified Embodiment

To the toner cartridge C2 according to the embodiment 5 or the modified embodiment thereof, the communicating portion (pressure releasing path) described in the embodiment 2 may also be added. For example, at the upper surface of the cartridge frame 32 of the toner cartridge C2 shown in part (a) of FIG. 25 to part (b) of FIG. 27, a hole portion or a filter portion may also be provided as the pressure releasing path. In the case where the pressure releasing path is provided, in the case where the air is charged into the air chamber 217, an amount of the air discharged from the discharge port 219 may only be required to be larger than an amount of the air discharged from the pressure releasing path. By providing the pressure releasing path, for example, in the case where the toner cartridge C2 is strongly gripped, it is possible to prevent that the internal pressure of the toner accommodating chamber 216 becomes excessively high.

### Embodiment 6

A toner cartridge C2 according to an embodiment 6 will be described. The toner cartridge C2 of this embodiment is mounted to the apparatus main assembly A of the image forming apparatus IF described in the embodiment 5 similarly as the toner cartridge C2 of the embodiment 5. In the following, elements to which reference symbols common to those of the embodiments 1 and 5 basically have the same constitutions and actions as those described in the embodiments 1 and 5 in the case where the elements are not particularly described, and a portion different from the embodiments 1 and 5 will be principally described.

### Extension Portion

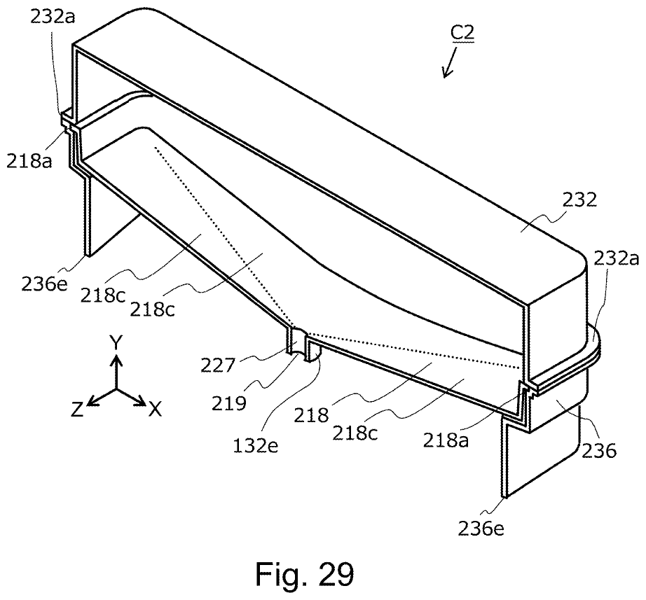

In this embodiment, a constitution orientation holding of the toner cartridge C2 will be described. FIG. 29 is a cross-sectional perspective view showing the toner cartridge C2 of this embodiment. The toner cartridge C2 includes an extension portion 236. The extension portion 236 extends downward (−Y side) than a lower end of the cartridge frame 232. The extension portion 236 projects downward (−Y side) than a lowermost portion of the filter 218 and a lower end (discharge port 219) of the discharge pipe 227.

An upper end portion of the extension portion 236 is bonded to a lower end portion (flange portion 232a) of the cartridge frame 232. A bonding method is not particularly limited, and for example, it is possible to select either one of the ultrasonic welding, the thermal welding, the bonding with the adhesive such as the hot-melt adhesive, and the mechanical bonding with the screws.

As viewed in the Y direction, the extension portion 236 is a hollow (annular, cylindrical) member with hole at a central portion thereof. A whole circumference of the upper end portion of the extension portion 236 and a whole circumference of the flange portion 232a are bonded to each other. When the toner cartridge C2 before mounted to the apparatus main assembly A is viewed in the Y direction, most of the filter 218 is exposed to an inside of the extension portion 236.

At a lower end of the extension portion 236, a second contact portion 236e contacting a second contacted portion 231e (parts (a) and (b) of FIG. 31) of the mounting portion 231 in the case where the toner cartridge C2 is mounted to the mounting portion 231 is provided. The second contact portion 236e is an end surface of the extension portion 236 in the mounting direction (arrow D of part (a) of FIG. 31) of the toner cartridge C2. Contact between the second contact portion 236e and the second contacted portion 231e will be described later. In this embodiment, over a whole circumference of the extension portion 236, a height of the second contact portion 236e in the Y direction is uniform.

Further, the toner cartridge C2 includes a first contact portion 132e for contacting a first contacted portion 131e of the mounting portion 231. A constitution of the first contact portion 132e and the first contacted portion 13le may also be the same as that described using, for example, parts (a) and (b) of FIG. 25.

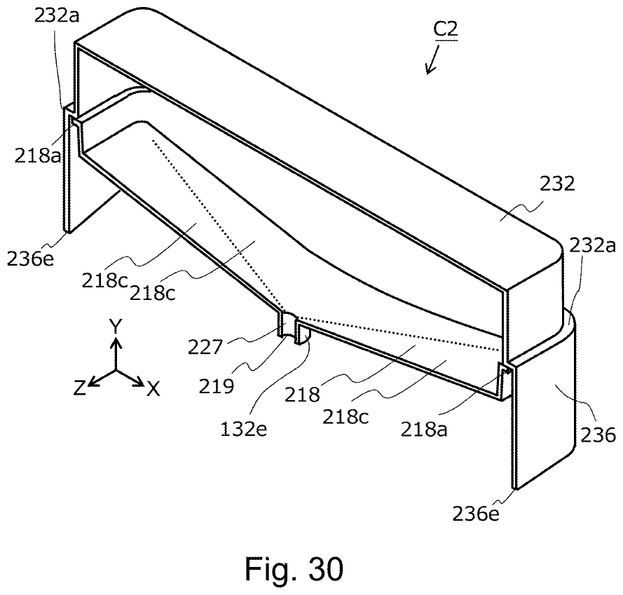

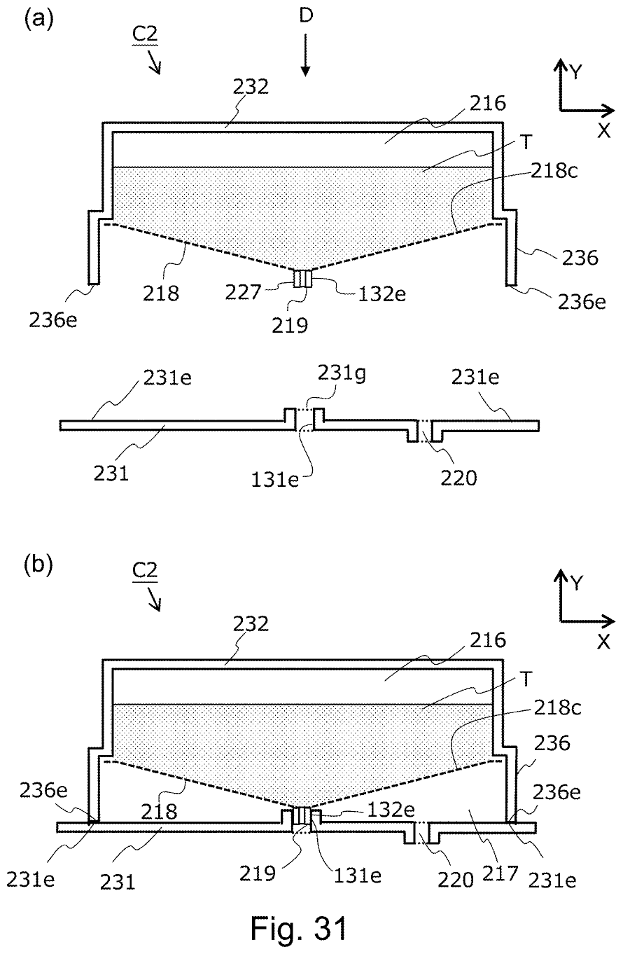

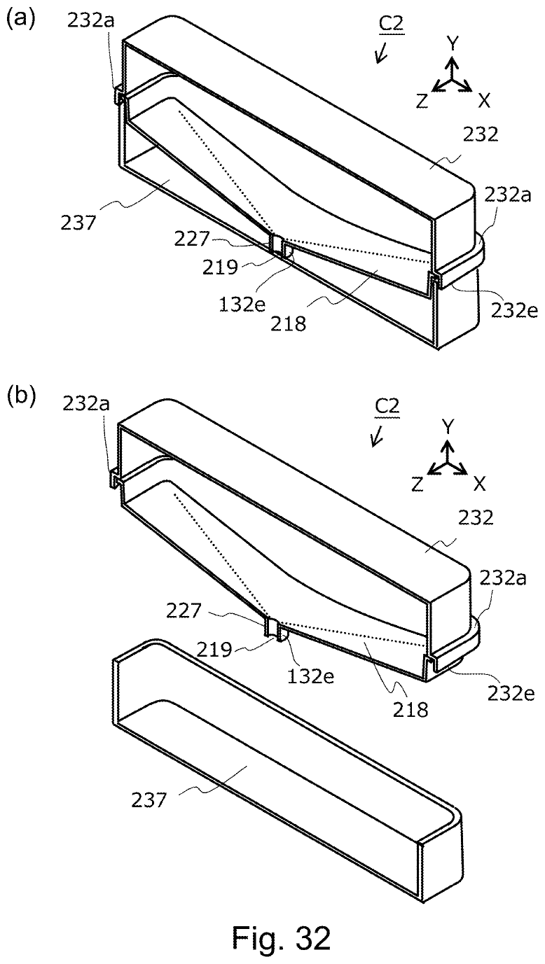

FIG. 30 is a cross-sectional perspective view showing a toner cartridge C2 according to a modified embodiment. The toner cartridge C2 of this modified embodiment includes an extension portion 236 as a part of the cartridge frame 232. The extension portion 236 extends downward (−Y side) from the flange portion 232a of the cartridge frame 232. The extension portion 236 projects downward (−Y side) than the lowermost portion of the filter 218 and a lower end (discharge port 219) of the discharge pipe 227.

As viewed in the Y direction, the extension portion 236 is formed in a hollow shape (annular shape, cylindrical shape) with a hole at a central portion thereof. When the toner cartridge C2 before mounted to the apparatus main assembly A is viewed in the Y direction, most of the filter 218 (most of the bottom of the toner accommodating chamber 216) is exposed to the inside of the extension portion 236.

At a lower end of the extension portion 236, the second contact portion 236e contacting the second contacted portion 231e (parts (a) and (b) of FIG. 31) of the mounting portion 231 in the case where the toner cartridge C2 is mounted to the mounting portion 231 is provided. The second contact portion 236e is an end surface of the extension portion 236 in the mounting direction (arrow D) of part (a) of FIG. 31) of the toner cartridge C2. Contact between the second contact portion 236e and the second contacted portion 231e will be described later. In this modified embodiment, over a whole circumference of the extension portion 236, a height of the second contact portion 236e in the Y direction is uniform.

Part (a) of FIG. 31 is an illustration showing a state before the toner cartridge C2 according to a modified embodiment is mounted to the mounting portion 231. Part (b) of FIG. 31 is an illustration showing a state in which the toner cartridge C2 according to the modified embodiment is mounted to the mounting portion 231.

When the toner cartridge C2 according to the modified embodiment is mounted to the mounting portion, the first contact portion 132e contacts the first contacted portion 131e, and the second contact portion 236e of the lower end of the extension portion 236 contacts the second contacted portion 231e of the mounting portion 231. By this, the air chamber 217 which is a space enclosed by the toner cartridge C2 and the mounting portion 231 is formed. Similarly, also in the case of the toner cartridge C2 according to the embodiment 6, the first contact portion 132e contacts the first contacted portion 131e, and the second contact portion 236e contacts the second contacted portion 231e, whereby the air chamber 217 is formed. At least one of the second contact portion 236e and the second contacted portion 231e may also be provided with a sealing member for improving adhesiveness between the second contact portion 236e and the second contacted portion 231e.

### Advantage of Extension Portion

In this embodiment and the modified embodiment, the extension portion 236 projects downward than the lower end (discharge port 219) of the discharge pipe 227 provided at the lower portion of the filter 218. For this reason, when the toner cartridge C2 is placed on a desk or the like, the filters 218 and the discharge pipe 227 do not contact the desk, so that a possibility that an orientation of the toner cartridge C2 becomes unstable can be reduced. Further, a possibility that dirt is deposited on the filter 218 and air permeability lowers and that dirt deposited on the discharge port 219 is mixed with the toner supplied to the process cartridge B can be reduced.

Further, in this embodiment and the modified embodiment, the second contact portion 236e is provided at the lower end of the extension portion 236 projecting downward (−Y side) than the lower end (discharge port 219) of the discharge pipe 227. For this reason, as shown in parts (a) and (b) of FIG. 31, for example, even in the case where a flat plate-shaped mounting portion 231 is used, the air chamber 217 can be appropriately formed, so that mounting of the toner cartridge C2 can be made easy. In other words, by providing the extension portion 236, a position where the toner cartridge C2 and the mounting portion 231 contact each other for forming the air chamber 217 can be set to a position separated from a bonding portion between the cartridge frame 232 and the filter 218.

According to the embodiment 6 and the modified embodiment thereof described above, it is possible to provide new forms of the image forming apparatus and the cartridge each provided with the constitution in which the toner is discharged from the cartridge by using the air.

### Embodiment 7

A toner cartridge C2 according to an embodiment 7 will be described. The toner cartridge C2 of this embodiment is mounted to the apparatus main assembly A of the image forming apparatus IF described in the embodiment 5 similarly as the toner cartridge C2 of the embodiment 5. In the following, elements to which reference symbols common to those of the embodiments 1 and 5 basically have the same constitutions and actions as those described in the embodiments 1 and 5 in the case where the elements are not particularly described, and a portion different from the embodiments 1 and 5 will be principally described.

### Protective Member

Part (a) of FIG. 32 is a cross-sectional perspective view of a toner cartridge C2 according to an embodiment 7. Part (b) of FIG. 32 is a cross-sectional perspective view showing the toner cartridge C2 in a state in which a protective member 237 is removed.

As shown in part (a) of FIG. 32, the toner cartridge C2 of this embodiment is provided with the protective member 237 (cover member) for protecting the filter 218 and the discharge pipe 227. The protective member 237 is mounted to the cartridge frame 232 so as to cover at least a part (preferably a whole) of the filter 218 when the toner cartridge C2 is viewed in the Y direction. Further, the protective member 237 is mounted to the cartridge frame 232 so as to cover at least a part (preferably a whole) of the discharge port 219 when the toner cartridge C2 is viewed in the Y direction.

The toner cartridge C2 includes a first contact portion 132e and a second contact portion 232e. A constitution of the first contact portion 132e and the second contact portion 232e may be the same as, for example, that described in the embodiment 5 (parts (a) and (b) of FIG. 25).

The protective member 237 is removable (detachable) from the cartridge frame 232 or movable relative to the cartridge frame 232 so as to expose the filter 218 and the discharge port 219. In the case where the toner cartridge C2 is mounted to the mounting portion 231, the protective member 237 is removed in advance (part (b) of FIG. 32). The user moves the toner cartridge C2 in the mounting direction (arrow D) to the mounting portion 231 in the state in which the protective member 237 is removed. By this, the first contact portion 132e and the second contact portion 232e contact the first contacted portion 131e and the second contacted portion 231e of the mounting portion 231, respectively, so that the air chamber 217 is formed (part (b) of FIG. 25). That is, by removing the protective member 237, the toner cartridge C2 becomes a state in which the toner cartridge C is appropriately mountable to the mounting portion 231.

### Advantage of Protective Member

In the case where the filter 218 is formed of a low-rigidity material such as a nonwoven fabric, when the filter 218 receives a strong force in the case where the filter 218 is supposed to contact a sharp object or in the like case, it would be considered that the filter 218 is broken and the toner is leaked out. In this embodiment, the filter 218 is protected by the protective member 237, so that a possibility that the filter 218 is broken can be reduced.

Incidentally, the material of the filter 218 is not limited to the nonwoven fabric, but is capable of being made to have high rigidity by a means such as heat press molding or sintering, for example. By enhancing strength of the filter 218 itself, a possibility that the filter 218 is broken can be reduced. Even in this case, by providing the protective member 237 in this embodiment, a possibility that the air permeability is lowered by deposition of the dirt on the filter 218, for example, in the case where the toner cartridge C2 is placed on the desk or in the like case.

Further, by covering the discharge pipe 227 (discharge port 219) with the protective member 237, it is possible to reduce a possibility that the discharge pipe 227 is broken and that dirt deposited on the discharge port 219 is mixed with the toner supplied to the process cartridge B.

According to the embodiment 7 and the modified embodiment thereof described above, it is possible to provide new forms of the image forming apparatus and the cartridge each provided with the constitution in which the toner is discharged from the cartridge by using the air.

### Other Embodiments

In the above-described embodiments, as an example of the “cartridge” detachably mountable to the apparatus main assembly of the image forming apparatus of the image forming apparatus, the toner cartridge C for supplying the toner to the process cartridge B was described. The “cartridge” is not limited to this, but may also be a cartridge having an all-in-one constitution in which the toner accommodating portion corresponding to the toner cartridge C and the process unit (corresponding to the process cartridge B) for receiving supply of the toner from the toner accommodating portion are integrated with each other. Further, the “cartridge” may also be one prepared by integrating the toner accommodating portion corresponding to the toner cartridge C and the developing unit B1 for receiving supply of the toner from the toner accommodating portion with each other. In these examples, to the toner accommodating portion corresponding to the toner cartridge C, the constitutions described in the above-described embodiments can be applied.

In the above-described embodiments, as an example of the “image forming means”, the process cartridge B used in the electrophotographic process of a direct transfer type was described. The “image forming means” is not limited to this, but may also be a process cartridge used in an electrophotographic process of an intermediary transfer type in which a toner image formed on a photosensitive drum is primarily transferred onto an intermediary transfer member such as an intermediary transfer belt and is transferred from the intermediary transfer member onto a recording material. Further, the “image forming means” may also be a process unit fixed to an apparatus main assembly A in an embodiment in which mounting and demounting thereof by the user is not assumed.

The constitutions described in the above-described embodiments or the above-described modified embodiments are capable of being applied at the same time in a single cartridge or a single image forming apparatus so far as they are not in consistent with each other.

### Summary of Present Disclosure

In the present disclosure, at least the following contents are included.

### Constitution 1

An image forming apparatus comprising:
a cartridge including a container which constitutes a first chamber for accommodating toner and in which at least a part of a bottom thereof is constituted by a filter which permits passage of air and which prevents passage of the toner;
an apparatus main assembly including a mounting portion to which the cartridge is mountable and a toner accommodating portion for accommodating the toner supplied from the cartridge mounted to the mounting portion; and
an air supplying portion for supplying the air,
wherein the mounting portion includes a wall portion which is constituted so as to constitute a second chamber having an upper surface defined by the filter in a state in which the cartridge is mounted and which is provided with an intake port for taking the air, from the air supplying portion, into the second chamber.

### Constitution 2

The image forming apparatus according to Constitution 1, wherein the wall portion includes a bottom wall including an opposing surface opposing the filter with an interval and a side wall provided around the filter and extending upward from the bottom wall as viewed in a gravitational direction, and
wherein the second chamber is surrounded by the filter, the bottom wall, and the side wall.

### Constitution 3

The image forming apparatus according to Constitution 2, wherein the intake port is provided in the bottom wall.

### Constitution 4

The image forming apparatus according to any one of Constitutions 1 to 3, wherein the container includes a container frame provided with an opening at the bottom, and
wherein the filter is provided so as to cover the opening.

### Constitution 5

The image forming apparatus according to Constitution 4, wherein the wall portion includes a bottom wall which is positioned below the cartridge and which includes an opposing surface opposing the filter with an interval,
wherein the container frame includes a container side wall which is provided around the filter and which extends toward the bottom wall as viewed in a gravitational direction, and
wherein the second chamber is surrounded by the filter and the container side wall.

### Constitution 6

The image forming apparatus according to Constitution 4 or 5, wherein the container frame includes a flange portion provided at an edge of the opening, and
wherein an outer edge portion of the filter is bonded to the flange portion.

### Constitution 7

The image forming apparatus according to any one of Constitutions 1 to 6, wherein the cartridge includes a discharge port for permitting discharge of the toner to an outside of the container and a contact portion contacting a contacted portion of the mounting portion in a state in which the cartridge is mounted to the mounting portion, and
wherein a contact region between the contact portion and the contacted portion has an annular shape, and the filter exists in a region, of a surface of the cartridge, on one side with respect to the contact region having the annular shape and the discharge port exists in a region, of a surface of the cartridge, on the other side with respect to the contact region having the annular shape.

### Constitution 8

The image forming apparatus according to Constitution 7, wherein at least one of the contact portion and the contacted portion is provided with a sealing member for sealing a gap between the contact portion and the contacted portion in the state in which the cartridge is mounted to the mounting portion.

### Constitution 9

The image forming apparatus according to any one of Constitutions 1 to 8, wherein the cartridge includes a discharge pipe provided with an inlet port communicating with the first chamber at one end and provided with a discharge port communicating with an outside of the container at the other end, and
wherein the mounting portion includes a hole into which the discharge pipe is inserted in a case where the cartridge is mounted to the mounting portion.

### Constitution 10

The image forming apparatus according to any one of Constitutions 1 to 9, wherein the cartridge includes a cover member which covers at least a part of the filter and which is provided removably or movably so as to expose the filter.

### Constitution 11

The image forming apparatus according to Constitutions 1 to 10, wherein the air supplying portion is an air pump.

### Constitution 12

A toner container detachably mountable to an image forming apparatus, comprising:
a container frame provided with a first opening communicating with an outside of the toner container and a second opening larger in area than the first opening; and
a filter for permitting passage of air and for preventing passage of toner, the filter covering the second opening,
wherein a toner accommodating chamber for accommodating the toner is constituted by the container frame and the filter,
wherein in a case where the toner container takes a mounting orientation, the toner container is constituted so that a bottom of the container frame is provided with the second opening, and
wherein the filter constitutes a part of an outer surface of the toner container.

### Constitution 13

The toner container according to Constitution 12, wherein in the toner accommodating chamber, a stirring member for stirring the toner is not provided.

### Constitution 14

The toner container according to Constitution 12 or 13, wherein the second opening occupies ½ or more of a portion corresponding to the toner accommodating chamber as viewed in a gravitational direction.

### Constitution 15

The toner container according to Constitution 12 or 13, wherein the second opening occupies a whole of a portion corresponding to the toner accommodating chamber as viewed in a gravitational direction.

### Constitution 16

The toner container according to any one of Constitutions 12 to 15, wherein in a case where the air flows into the toner accommodating chamber through the filter, a path through which the air is discharged from the toner accommodating chamber to an outside of the toner container is only the first opening.

### Constitution 17

The toner container according to any one of Constitutions 12 to 15, wherein the container frame further includes a third opening communicating with an outside of the toner container, and
wherein in a case where the air flows into the toner accommodating chamber through the filter, an amount of the air discharged through the first opening is larger than an amount of the air discharged through the third opening.

### Constitution 18

The toner container according to any one of Constitutions 12 to 17, further comprising a discharge pipe provided with an inlet port, at one end, through which the toner in the toner accommodating chamber flows in and provided with the first opening at the other end,
wherein the inlet port opposes the filter in a gravitational direction, and
wherein in a case where the toner container takes a mounting orientation, the filter is constituted by an inclined surface inclined so that a portion of the filter opposing the inlet port becomes a lowermost portion of the filter.

### INDUSTRIAL APPLICABILITY

According to the present invention, it is possible to provide a new embodiment of the image forming apparatus and the toner container.

The present invention is not limited to the above-described embodiments, but can be variously changed and modified without departing from the spirit and the scope of the present invention. Accordingly, the following claims are attached for making the scope of the present invention public.

The present application claims priority on the basis of Japanese Patent Application No. 2023-200228 filed on Nov. 27, 2023, which is hereby incorporated by reference herein in its entirety.

1. An image forming apparatus comprising:
a cartridge including a container which constitutes a first chamber for accommodating toner and in which at least a part of a bottom thereof is constituted by a filter which permits passage of air and which prevents passage of the toner;
an apparatus main assembly including a mounting portion to which the cartridge is mountable and a toner accommodating portion for accommodating the toner supplied from the cartridge mounted to the mounting portion; and
an air supplying portion for supplying the air,
wherein the mounting portion includes a wall portion which is constituted so as to constitute a second chamber having an upper surface defined by the filter in a state in which the cartridge is mounted and which is provided with an intake port for taking the air, from the air supplying portion, into the second chamber.

2. The image forming apparatus according to claim 1, wherein the wall portion includes a bottom wall including an opposing surface opposing the filter with an interval and a side wall provided around the filter and extending upward from the bottom wall as viewed in a gravitational direction, and
wherein the second chamber is surrounded by the filter, the bottom wall, and the side wall.

3. The image forming apparatus according to claim 2, wherein the intake port is provided in the bottom wall.

4. The image forming apparatus according to claim 1, wherein the container includes a container frame provided with an opening at the bottom, and
wherein the filter is provided so as to cover the opening.

5. The image forming apparatus according to claim 4, wherein the wall portion includes a bottom wall which is positioned below the cartridge and which includes an opposing surface opposing the filter with an interval,
wherein the container frame includes a container side wall which is provided around the filter and which extends toward the bottom wall as viewed in a gravitational direction, and
wherein the second chamber is surrounded by the filter and the container side wall.

6. The image forming apparatus according to claim 4, wherein the container frame includes a flange portion provided at an edge of the opening, and
wherein an outer edge portion of the filter is bonded to the flange portion.

7. The image forming apparatus according to claim 1, wherein the cartridge includes a discharge port for permitting discharge of the toner to an outside of the container and a contact portion contacting a contacted portion of the mounting portion in a state in which the cartridge is mounted to the mounting portion, and
wherein a contact region between the contact portion and the contacted portion has an annular shape, and the filter exists in a region, of a surface of the cartridge, on one side with respect to the contact region having the annular shape, and the discharge port exists in a region, of a surface of the cartridge, on the other side with respect to the contact region having the annular shape.

8. The image forming apparatus according to claim 7, wherein at least one of the contact portion and the contacted portion is provided with a sealing member for sealing a gap between the contact portion and the contacted portion in the state in which the cartridge is mounted to the mounting portion.

9. The image forming apparatus according to claim 1, wherein the cartridge includes a discharge pipe provided with an inlet port communicating with the first chamber at one end and provided with a discharge port communicating with an outside of the container at the other end, and
wherein the mounting portion includes a hole into which the discharge pipe is inserted in a case where the cartridge is mounted to the mounting portion.

10. The image forming apparatus according to claim 1, wherein the cartridge includes a cover member which covers at least a part of the filter and which is provided removably or movably so as to expose the filter.

11. The image forming apparatus according to claim 1, wherein the air supplying portion is an air pump.

12. A toner container detachably mountable to an image forming apparatus, comprising:
a container frame provided with a first opening communicating with an outside of the toner container and a second opening larger in area than the first opening; and
a filter for permitting passage of air and for preventing passage of toner, the filter covering the second opening,
wherein a toner accommodating chamber for accommodating the toner is constituted by the container frame and the filter,
wherein in a case where the toner container takes a mounting orientation, the toner container is constituted so that a bottom of the container frame is provided with the second opening, and
wherein the filter constitutes a part of an outer surface of the toner container.

13. The toner container according to claim 12, wherein in the toner accommodating chamber, a stirring member for stirring the toner is not provided.

14. The toner container according to claim 12, wherein the second opening occupies ½ or more of a portion corresponding to the toner accommodating chamber as viewed in a gravitational direction.

15. The toner container according to claim 12, wherein the second opening occupies a whole of a portion corresponding to the toner accommodating chamber as viewed in a gravitational direction.

16. The toner container according to claim 12, wherein in a case where the air flows into the toner accommodating chamber through the filter, a path through which the air is discharged from the toner accommodating chamber to an outside of the toner container is only the first opening.

17. The toner container according to claim 12, wherein the container frame further includes a third opening communicating with an outside of the toner container, and
wherein in a case where the air flows into the toner accommodating chamber through the filter, an amount of the air discharged through the first opening is larger than an amount of the air discharged through the third opening.

18. The toner container according to claim 12, further comprising a discharge pipe provided with an inlet port, at one end, through which the toner in the toner accommodating chamber flows in, and provided with the first opening at the other end,
wherein the inlet port opposes the filter in a gravitational direction, and
wherein in a case where the toner container takes a mounting orientation, the filter is constituted by an inclined surface inclined so that a portion of the filter opposing the inlet port becomes a lowermost portion of the filter.
